(19) United States
(12) Patent Application Publication
(10) Pub. No.: US 2026/0058579 A1
(43) Pub. Date: Feb. 26, 2026

(54) PIEZOELECTRIC POWER GENERATOR

(71) Applicant: Manumit Energy, Inc., Troy, MI (US)

(72) Inventor: Douglas Magyari, Royal Oak, MI (US)

(21) Appl. No.: 19/306,697

(22) Filed: Aug. 21, 2025

Related U.S. Application Data
(60) Provisional application No. 63/685,953, filed on Aug. 22, 2024.

(51) Int. Cl. H02N 2/18; H02J 50/00; H02N 2/10; H02N 2/12

(52) U.S. Cl. CPC H02N 2/186; H02J 50/001; H02N 2/103; H02N 2/12

(57) ABSTRACT

The present application is directed to systems and processes for generating electrical power from piezoelectric elements. One exemplary implementation is a system that includes a rotor, a piston, multiple holders, and a plurality of piezoelectric elements. The holders are disposed in a consecutive arrangement that extends radially away from an outer circumferential surface of the rotor, and each holder has one or more openings defined therethrough. The piezoelectric elements housed in each holder are disposed in respective openings of the corresponding holder. The piezoelectric elements corresponding to an innermost one of the holders is mechanically coupled to the outer circumferential surface of the rotor via the piston. And, an electrical contact is disposed between each pair of adjacent holders such that the piezoelectric crystals corresponding to each holder are connected in a parallel circuit.

### CROSS-REFERENCE TO RELATED APPLICATION

This application claims the benefit of the filing date of U.S. Provisional Application No. 63/685,953, filed on Aug. 22, 2024. The contents of U.S. Application No. 63/685,953 are incorporated herein by reference in their entirety.

### BACKGROUND

Electricity can be produced using various methods, including chemical reactions (e.g., batteries), photovoltaics (e.g., solar cell production), friction (e.g., static electricity production such as with a Wimshurst generator), thermal production (e.g., using the Seebeck effect), and mechanical deformation of piezoelectric materials. Most conventional electricity production methods involve induction-based methods.

### SUMMARY

This document reflects the inventor's work and discoveries in the field of piezoelectric power generation. Throughout these efforts, many surprising and unexpected results have been obtained, including the ability to generate and capture large amounts of electrical energy from piezoelectric elements with remarkable efficiency. In addition, this document contains the inventor's solutions to many known problems in the art and to problems unknown in the art that the inventor himself discovered. Examples include the structure and arrangement of the rocker arm, the configuration of the flywheel cam surface, the particular geometric shape of the piezoelectric elements, the triggering system/process for capturing charge from piezoelectric elements, and piezoelectric generator operating processes. These and other examples are explained throughout this document.

The applications for this work are as widespread and diverse as the need for electricity in the marketplace. A vast amount of electricity is generated today by using a fuel source (fossil fuels, nuclear fusing, nuclear fission, or concentrated solar) to create heat. That heat is then used to create steam, which is then used to turn a turbine. The steam-powered turbine shaft is then connected to an electric generator in order to convert rotational energy into usable electricity. Many efficiencies are lost during this process, much of it due to the Back Electromotive Force (EMF) that is inherent in magnetic induction based electric generators. Back EMF is the electromotive force manifesting as a voltage that opposes the change in current which induced it. This resistance has to be overcome to produce energy which reduces the efficiency of induction-based power generation. The total system efficiency for these systems varies but on average can reasonably be calculated to be around 35-45%.

There are five other ways to create electricity that do not produce Back EMF. Two of the five are by using friction (Wimshurst Generator) or by using thermal differences (Seebeck effect). However, neither of these methods are viable for commercial applications because they are not capable of producing enough current; they typically only produce current in the milliamp range. A third method to generate electricity is by using battery chemistry. Although this method has a relatively high (approximately 60%) efficiency, it has only found wide-spread commercial acceptance as an electricity storage method, not as a method of electricity generation. There are many reasons for this including that batteries require an external electrical power source for recharging, and the cost of batteries still remains quite high. The fourth method is by using photo voltaic materials, such as thin film solar cells but this method is substantially less efficient (approximately 20%) than induction-based power generation. The fifth method is by using the piezoelectric effect, which is the subject of this document.

There exists a long felt but unmet need in the market for the generation of large amounts of electricity by a system that has on the order of 75% efficiency, or more. The inventor's work and discoveries in the field of piezoelectric power generation, as explained below in detail, meet that need. The approaches disclosed and described herein achieve compact, powerful (kW, MW, and GW), and efficient power generation that can be used anywhere there exists a need for efficiently produced electricity. In addition, the approaches described herein can have one or more of the following advantages. Power generation using the piezoelectric generators described here is efficient and low loss, e.g., because piezoelectric generators do not experience counter electromotive force (back EMF). This efficiency, in combination with the structure and operation of these generators and energy conversion systems, enables production of large amounts of power.

For instance, systems such as these can produce voltage pulses having a peak voltage of at least about 5 kiloVolts (kV) and a duration of less than about 2 milliseconds (ms) and can generate at least about 5 kiloWatts (kW) of output power. The power generation by these systems produces low emissions, and thus they are clean and environmentally friendly approaches to power generation. Moreover, the efficiency of these power generation methods provides economic advantages over conventional approaches to power generation.

These generators and associated energy conversion systems are scalable, e.g., for application in various contexts including providing power for discrete fixtures (e.g., data centers, hospitals, factories), transient situations (e.g., transient military installations), infrastructure (e.g., local electric grid services), or small-scale electrical devices (e.g., hand-powered tools or desktop/tabletop devices).

The details of one or more implementations are set forth in the accompanying drawings and the description below. Other features and advantages will be apparent from the description and drawings, and from the claims.

### BRIEF DESCRIPTION OF DRAWINGS

FIG. 1 is a block diagram of a system for power generation using piezoelectric elements.

FIG. 2 is a block diagram of a system for power generation using piezoelectric elements.

FIGS. 3A-3B are front and side views, respectively, of a piezoelectric power generator with a single radially extending cartridge of piezoelectric elements.

FIG. 4 is a perspective view of a piezoelectric power generator with multiple radially extending cartridges of piezoelectric elements

FIG. 5 is a perspective view of the piezoelectric power generator of FIG. 4 with an outer cover removed.

FIG. 6 is an exploded view of the piezoelectric power generator of FIG. 4.

FIG. 7 is an exploded view of a piezoelectric cartridge for a piezoelectric power generator.

FIG. 7A is a diagram of an exemplary 10×10 arrangement of piezoelectric elements in an exemplary holder.

FIG. 8 illustrates piezoelectric elements for a piezoelectric power generator.

FIGS. 9A-9C are diagrams of holders for a piezoelectric generator.

FIG. 10A is a plan view of a rotor.

FIG. 10B is a diagram of a period of the lobes on the rotor of FIG. 10A.

FIG. 11 is a diagram of a rocker arm.

FIG. 12 is a diagram of a piezoelectric cartridge with a servo motor and control system.

FIG. 13 is a perspective view of a power generation system with multiple piezoelectric power generators coupled to a common drive shaft.

FIGS. 14-15 are diagrams of an example energy harvesting system for collecting energy from a power generation system.

FIG. 16 is a diagram showing signal timings and charge collection characteristics of an energy harvesting system.

FIGS. 17A-17C are diagrams of other example energy harvesting systems for collecting energy from a power generation system.

FIG. 18 is a flowchart illustrating an example process for generator startup.

FIG. 19 is a flowchart illustrating an example process for a generator fault response.

FIG. 20 is a flowchart illustrating an example process for voltage output control for a piezoelectric generator.

### DETAILED DESCRIPTION

We describe here devices, systems, and methods for generating large amounts of electrical power using piezoelectric elements, such as piezoelectric crystals. These approaches involve repeated compression and relaxation of piezoelectric elements (e.g., periodic compression and relaxation cycles) to generate a voltage, from which electrical power can be generated. For instance, systems such as these can produce voltage pulses having a peak voltage in the kiloVolt range, e.g., a peak voltage of at least about 5 kiloVolts (kV) and a duration of less than about 2 milliseconds (ms). From these voltage pulses, the system can generate electrical output power in the range of kiloWatts, e.g., at least about 5 kiloWatts (kW) of output power.

The capability of these piezoelectric generators to produce large amounts of power is due, at least in part, to their efficient operation. For instance, piezoelectric generators do not experience counter electromotive force (back EMF), which is an opposing voltage that, in conventional electric generators, is caused by relative motion between the armature and the magnetic field of the rotor. In conventional electric generators, to overcome this back EMF, additional mechanical force is required as the electrical load on the generator increases, thereby degrading the efficiency of the power generation. By contrast, because the piezoelectric generators described here do not experience back EMF, their operation is more efficient, enabling efficient conversion of input mechanical energy into large amounts of electrical power. Unlike conventional electric generators, piezoelectric generators tend to exhibit a constant mechanical resistance independent of the electrical power draw. Moreover, the amount of charge and output voltage generated by piezoelectric elements is dependent on multiple characteristics of the elements including size, shape, aspect ratio, crystalline structure, and the amount of compressive force applied to the element. Thus, the efficiency of power generation by a piezoelectric generator can be altered by using piezoelectric elements with different characteristics. In addition, the output can be controlled by changing the pressure applied to a given set of piezoelectric elements.

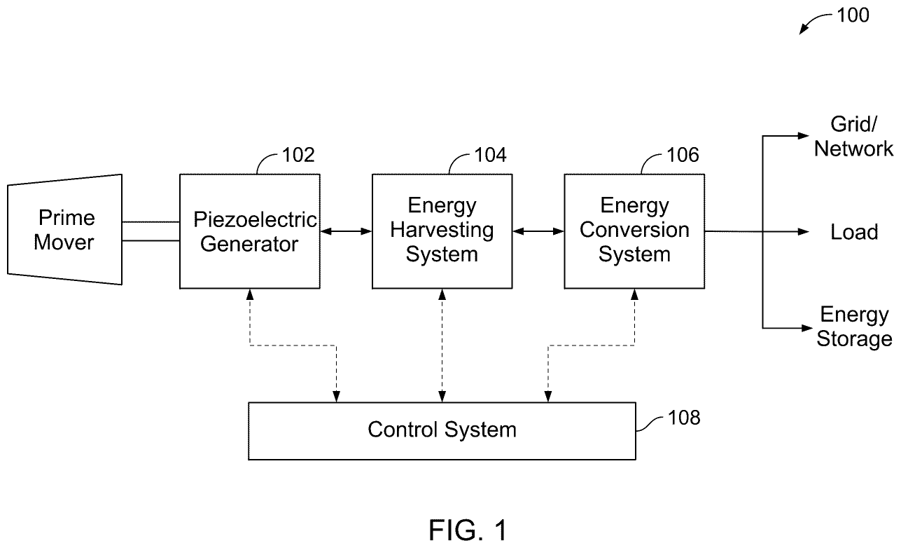

FIG. 1 is a block diagram of a system 100 for electrical power generation using piezoelectric elements, such as piezoelectric crystals. The system 100 includes a piezoelectric generator 102, an energy harvesting system 104, an energy conversion system 106, and a control system 108. These components together enable production of large amounts of electrical power by repeated (e.g., periodic) compression and relaxation of piezoelectric elements to generate a voltage from an accumulation of electrical charge, and convert the charge to useful electric power. For instance, systems such as these can produce voltage pulses having a peak voltage of at least about 5 kiloVolts (kV), e.g., at least about 10 kV and a duration of less than about 2 milliseconds (ms) and can generate at least about 5 kiloWatts (kW) of output power, e.g., at least about 10 kW.

The piezoelectric generator 102 converts mechanical energy from a prime mover 101 (e.g., a gas turbine, steam turbine, wind turbine, water turbine, heat engine, combustion engine, or other device) into electrical energy. Generally, a rotating cam applies repeatedly varying stress to one or more piezoelectric elements, causing a voltage build up across each piezoelectric element which results in a current flowing into the energy harvesting system 104. In some implementations, the rotating cam applies a repeatedly (e.g., periodically) varying stress to multiple banks of piezoelectric elements, with each bank creating a pulse of voltage and current flow.

The energy harvesting system 104 collects electric energy from the piezoelectric elements in the piezoelectric generator 102. In general, the energy harvesting system collects electrical energy from the piezoelectric elements in both the compression and relaxation portions of their cycle, and momentarily stores that energy such that it can be converted into useful electrical power by the energy conversion system 106. In some implementations, the energy harvesting system 104 uses one or more high voltage switches (e.g., silicon carbide switches, diamond switches, spark gaps including plasma switches, ignitron switches, or trigatron switches, or metal oxide semiconductor field-effect transistors (MOSFETs), or other solid state switches including insulated gate bipolar transistors (IGBTs), integrated gate-commutated thyristor (IGCTs), or Thyristors) and transformer(s) (e.g., a pulse transformer) and/or inductor(s) in a converter to harness the relatively high voltages generated by the piezoelectric elements (e.g., 5 kV or more, or 10 kV or more) and charge a high voltage capacitor. For example, in a 250 Watt system, operation of high voltage switches and converters can charge an 8 μF capacitor to 900 volts, or 2000 volts or greater. In some implementations, the piezoelectric generator 102 has multiple sets of piezoelectric elements. The energy harvesting system includes a dedicated energy harvesting circuit for each set of piezoelectric elements. Each energy harvesting circuit has a converter (e.g., arranged in a flyback converter or other configuration) and capacitor. In some implementations, the capacitors for each set of piezoelectric elements are connected in parallel, forming a capacitor bank from which the energy conversion system 106 can withdraw.

The energy conversion system 106 is a DC-DC or DC-AC converter that steps down the high voltage generated by the energy harvesting system 104 to a voltage more suitable for use with electrical loads, such as an electric grid, an energy storage system, or another appropriate load. In general, the energy conversion system 106 can be a buck converter, buck-boost converter, flyback or fly-forward converter, or other converter. The converters of the energy conversion system can be linear or switching converters, isolated or non-isolated converters among other types.

The control system 108 sends switching signals to control various components within the power generation system 100 based on sensed parameters. In general, the control system 108 can include multiple independent or co-dependent controllers that operate to keep the system 100 in a specified operational state. For example, control system 108 can control the speed of the piezoelectric generator 102, and thereby adjust the overall system output. The control system 108 can send switching commands to MOSFETs or other solid state components of energy harvesting system 104 and energy conversion system 106, to adjust output. In some implementations the control system senses parameters associated with the system 100 including speed, temperature, voltage, frequency, power, current, pressure, etc. The control system 108 uses the sensed parameters to manipulate or adjust the operation of the system 100 including adjusting switching frequency and phase, output setpoints (e.g., target output voltage), rotational speed, fuel flow, or other parameters by using one or more control algorithms. Control algorithms can be classical algorithms such as PID controllers, or modern controls such as state space control, robust control, fuzzy logic, machine learning, or others. While illustrated as a single component, control system 108 can be distributed throughout the other components of FIG. 1. For example, piezoelectric generator 102 can include a governor that independently regulates the speed of its prime mover to a predetermined target speed. In some implementations, a single control system 108 controls multiple power generation systems 100.

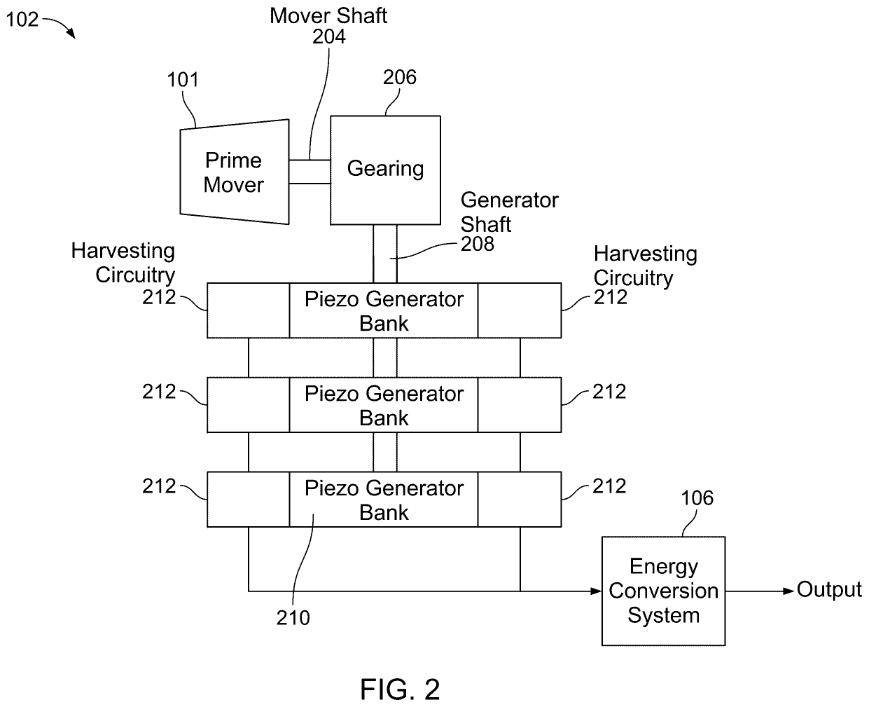

Referring to FIG. 2, the piezoelectric generator 102 receives input energy from prime mover 101, which drives rotation of a mover shaft 204. The mover shaft 204 is mechanically coupled via gearing 206 to a generator drive shaft 208. The generator drive shaft 208 drives rotation of a rotor that applies a repeated mechanical compression and relaxation cycle to one or more banks 210 of piezoelectric elements. Each bank includes a stack of consecutively arranged piezoelectric elements. This repeated compression and relaxation results in generation of a voltage in the piezoelectric elements, which is captured as a current by harvesting circuitry 212. The harvesting circuitry connects the banks 210 of piezoelectric elements in parallel and connects the individual piezoelectric elements in each bank in parallel, to maximize power output from the piezoelectric generator 102. The collected current is provided to the conversion system 106 for processing into a usable form, e.g., to step down the high voltage output on the harvesting circuitry 212 to a voltage more suitable for use with electrical loads.

The piezoelectric generators described here can be used to generate power in various contexts, and the size and power output of the piezoelectric generators can be designed based on the intended context of use. Example piezoelectric generators can be installed as fixed units to provide power to discrete fixtures, such as data centers, hospitals, factories, or other such fixtures. In some examples, piezoelectric generators can be installed to supplement or replace power provided by an electric grid, e.g., to provide locally generated power to a neighborhood. In some examples, piezoelectric generators can be transportable to provide power in transient situations such as military or research installations. For instance, piezoelectric generators can be provided as prefabricated, transportable units, e.g., contained in a transportable shipping container. In some examples, small-scale piezoelectric generators can be used to provide power to handheld or tabletop tools, computing devices, or other devices drawing relatively small amounts of electrical power. In some examples, piezoelectric generators can be used in hybrid vehicles, e.g., trucks, automobiles, ships, trains, and aircraft. For example, piezoelectric generators can be used to provide electric power to charge batteries and/or operate electric motors.

Example sizes and output powers for various scales of piezoelectric generators are provided in the following table. The input power in the table below is estimated for a full electric power generation system from fuel source, through a prime mover (e.g., a turbine), and to the electrical output of a piezoelectric generator. The input power is estimated based on a 60% full system efficiency observed during the inventor's laboratory proof of concept testing and a theoretically estimated 75% full system efficiency extrapolated from such tests (discussed in more detail below).

| | | Input power | | | |
|---|---|---|---|---|---|
| Generator type | Approx. size | (estimated) | | Output power | |
| Tabletop | 6″ × 6″ × 10″. | 13.3-16.7 | | 10 | W |
| Shipping container | 8′ × 8′ × 20′ | 667-714 | kW | 500 | kW |
| (e.g., for transient | | | | | |
| situations) | | | | | |
| Fixed installation | 8′ × 8′ × 10′ | 333-427 | kW | 250 | kW |
| (e.g., for data | | | | | |
| centers) | | | | | |
| Power grid | 12′ × 12′ × 20′ | 1.3-1.4 | MW | 1 | MW |
| supplement (e.g., | (per unit) | | | | |
| for neighborhood | | | | | |
| power) | | | | | |
| Utility power | 18′ × 18′ × 40′ | 1.3-1.4 | GW | 1 | GW |

| | |
|---|---|
| station | (per unit) |

### Single Cartridge Piezoelectric Generator

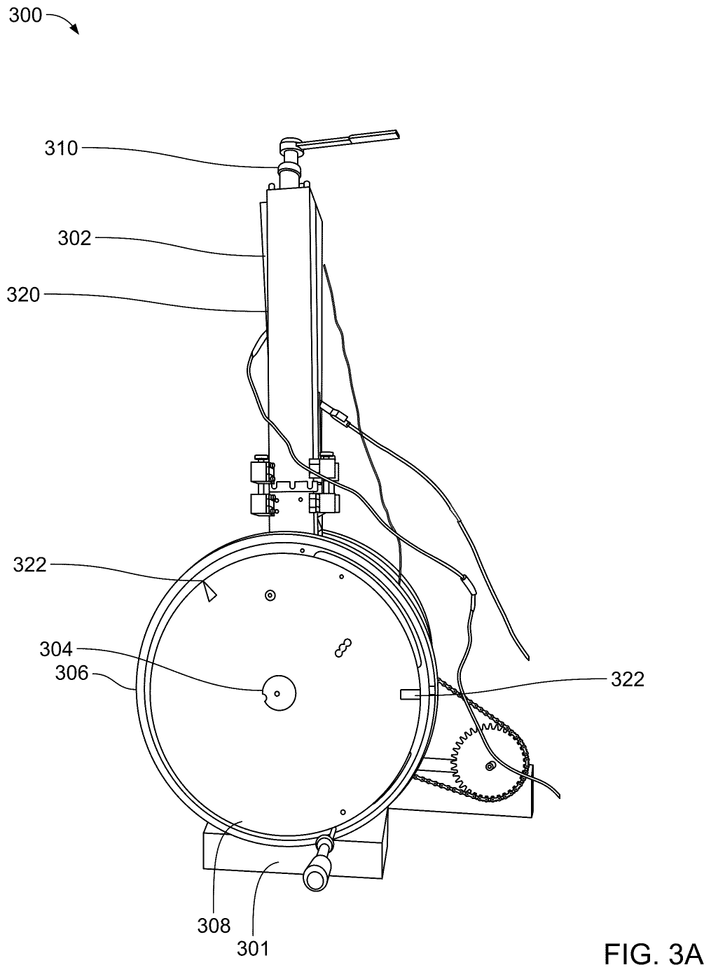

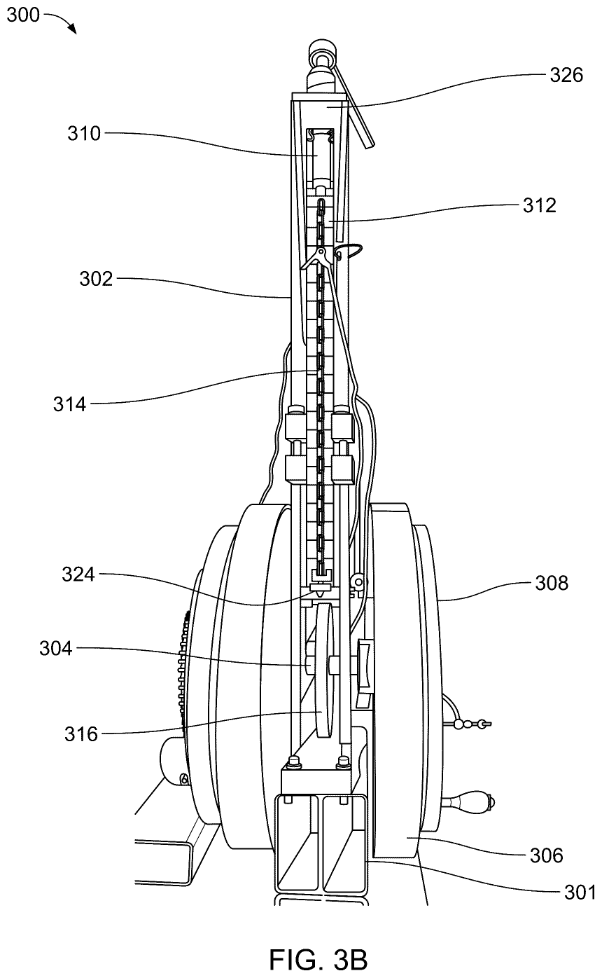

FIGS. 3A-3B are front and side views of an example prototype piezoelectric power generator 300 built by the inventor for proof-of-concept testing. The piezoelectric power generator 300 has a single, radially extending piezoelectric cartridge 302 containing piezoelectric elements for power generation. Voltage from the piezoelectric elements in the piezoelectric cartridge 302 is captured and provided to an energy harvesting system for storage and conversion.

The piezoelectric power generator 300 includes a rotor 316 mounted on a drive shaft 304 such that rotation of the drive shaft 304 causes rotation of the rotor 316. In the example of FIGS. 3A-3B, the drive shaft 304 can be driven by an electric motor or rotated manually. A flywheel 306 is mounted to the driveshaft 304. They flywheel 306 maintains the inertia of the drive shaft 304 rotation. In some examples, the drive shaft 304 is coupled to a prime mover (e.g., a turbine, engine, or other device) providing mechanical input to cause the rotation of the drive shaft 304 and rotor 316.

Proof of concept testing was performed using piezoelectric generator 300. Piezoelectric generator 300 was driven by an electric motor to operate a 50 W set of high voltage neon lighting. Output power was measured at 50 W. The input power measured at the electric motor was 84 W, resulting in a 60% full system efficiency. The same electric motor was also used to drive a traditional induction generator to operate a 50 W incandescent light bulb. Output power was measured at 50.3 W and the input power measured at the electric motor was 181 W, resulting in a 28% full system efficiency. Piezoelectric generator 300 was more than twice as efficient at converting mechanical input to electrical output as the induction generator while using the same prime mover. With such an improvement in mechanical to electrical energy efficiency, piezoelectric generators have the potential to substantially reduce electricity costs and emissions.

In operation, each piezoelectric element functions at least partially as a spring that returns some energy to the rotor 316 during decompression. In a specific example, approximately 50% of the energy consumed to compress each piezoelectric element is returned to the rotor during the decompression. The decompression of the piezoelectric elements contributes to rotation of the rotor 316, e.g., as an energy input. The prime mover that provides input rotation to the drive shaft 304, supported by the inertia of flywheel rotation provides the difference between the returned mechanical energy from the decompression of the piezoelectric elements and the required energy to recompress the piezoelectric elements. By returning energy from the decompressing piezoelectric elements to the system, the amount of external input energy (e.g., from the prime mover) required to maintain rotation of the flywheel can be reduced, thus improving energy efficiency of the power generation. The flywheel 306 provides inertial momentum that smooths out fluctuation in the rotational velocity of the rotor 316, thereby enabling continuous, smooth operation of the piezoelectric power generator 300.

The rotational speed of the rotor is established based on various factors, including the spring rate and restitution speed of the piezoelectric elements and the mass of the flywheel and of the piezoelectric elements. In a specific example, a tabletop sized piezoelectric generator may operate at about 40-60 revolutions per minute (rpm), producing an electrical output having a frequency of 35-50 cycles per second (cps). Other, larger generators may operate at rotational speeds that produce an output having a frequency of 100-300 cps for example, but it should be noted that in some examples, the output frequency may be determined based on operating characteristics of the power electronics. In a specific example, a 24-inch diameter rotor with 50 lobes and operated at 60 rpm will produce 100 cps.

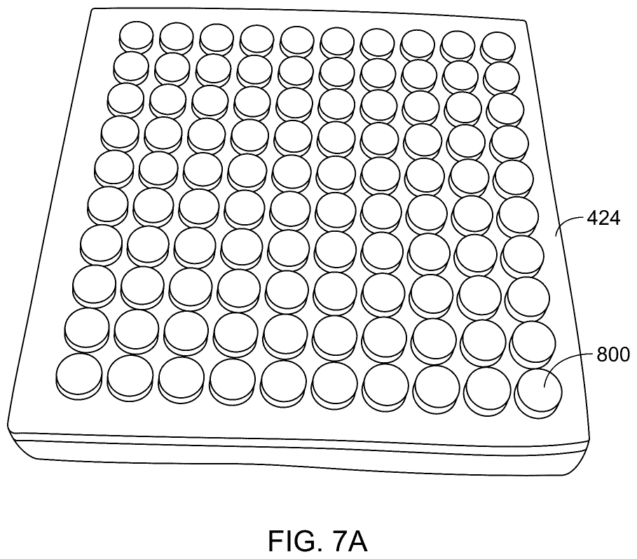

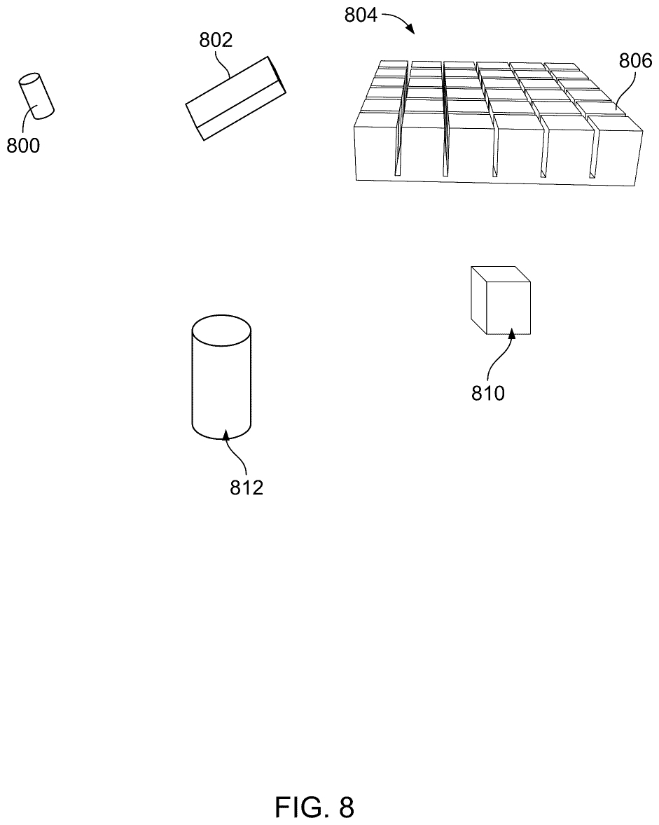

The piezoelectric cartridge 302 includes a housing 320 attached to a base 301. The housing 320 extends radially away from an outer circumference of the rotor 316 such that a proximal end 324 of the housing 320 abuts the rotor 316. The proximal end of the housing is the end of the housing that is closest to the rotor; a distal end of the housing is the end of the housing that is furthest from the rotor. The housing 320 contains multiple piezoelectric holders 312 disposed consecutively in a stack along the length of the housing. Each piezoelectric holder 312 houses one or more piezoelectric elements (see FIG. 8). In some examples, the piezoelectric elements are elongated elements (e.g., cylindrical elements with a length greater than a diameter) and are disposed in the piezoelectric holders 312 such that the long axis of each piezoelectric element is aligned with the length of the housing 320. The piezoelectric holders 312 hold the piezoelectric elements in an end-to-end arrangement along the length of the housing, forming banks (e.g., stacks) of consecutively arranged piezoelectric elements. Each bank of piezoelectric elements has multiple piezoelectric elements, e.g., 10, 20, 30, 40, 50, 100, 1000, or more than 1000 piezoelectric elements.

In some examples, a bank of piezoelectric elements can contain between 10 to 1000 piezoelectric elements. For instance, in one example, holders 312 can be configured to each hold a single piezoelectric element and ten holders 312 can be stacked in a bank within a housing 320, yielding a bank of 10 piezoelectric elements. As another example, holders 312 can be configured to each hold 25 piezoelectric elements (e.g., in a 5×5 arrangement) and ten holders 312 can be stacked in a bank within a housing 320, yielding a bank of between 250 piezoelectric elements. As another example, holders 312 can be configured to each hold 100 piezoelectric elements (e.g., in a 10×10 arrangement) and ten holders 312 can be stacked in a bank within a housing 320, yielding a bank of 1000 piezoelectric elements. As another example, holders 312 can be configured to each hold 50 piezoelectric elements (e.g., in a 5×10 arrangement) and five-fifteen holders 312 can be stacked in a bank within a housing 320, yielding a bank of between 250-750 piezoelectric elements. As another example, holders 312 can be configured to each hold 144 piezoelectric elements (e.g., in a 12×12 arrangement) and five holders 312 can be stacked in a bank within a housing 320, yielding a bank of between 720 piezoelectric elements. As another example, holders 312 can be configured to each hold 225 piezoelectric elements (e.g., in a 15×15 arrangement) and ten-twelve holders 312 can be stacked in a bank within a housing 320, yielding a bank of between 2250-2700 piezoelectric elements. As yet another example, bank of piezoelectric elements can contain a single holder 312 (e.g., a single stack) with a 10×10 arrangement of piezoelectric elements, yielding a bank of 100 piezoelectric elements. As yet another example, bank of piezoelectric elements can contain a single holder 312 (e.g., a single stack) with a 5×5 arrangement of piezoelectric elements, yielding a bank of 25 piezoelectric elements.

Although the housing 320 is shown in FIG. 3A-3B as extending vertically, in some examples, the piezoelectric generator is rotated by 90° so that the rotor 316 lies in a horizontal plane (or substantially horizontal plane) and the housing extends horizontally from the rotor. The horizontal orientation reduces the effect of gravitational forces on the piezoelectric elements within the piezoelectric cartridge by shifting the gravitational force to a plane orthogonal to a compression axis.

Electrical wiring 314 is connected to positive and negative poles of each piezoelectric element and electrically connects the piezoelectric elements in a parallel circuit configuration. The piezoelectric elements in each piezoelectric holder 312 are wired in parallel, and the piezoelectric holders 312 are also wired in parallel. The parallel wiring configuration of the piezoelectric elements and the holders 312 limits the output voltage of piezoelectric cartridge (e.g., each stack of piezoelectric elements) to the output voltage of a single piezoelectric element, e.g., for safety and other purposes. However, it permits the compounding of the electrical charge that is output by the piezoelectric elements and increases the current output of the piezoelectric generator 300. Adding additional piezoelectric elements increases the current output, and consequently the electrical power output, of the piezoelectric generator 300. The electrical wiring 314 connects to the energy harvesting and conversion systems for harvesting of voltage from the piezoelectric elements generated by operation of the piezoelectric generator 300.

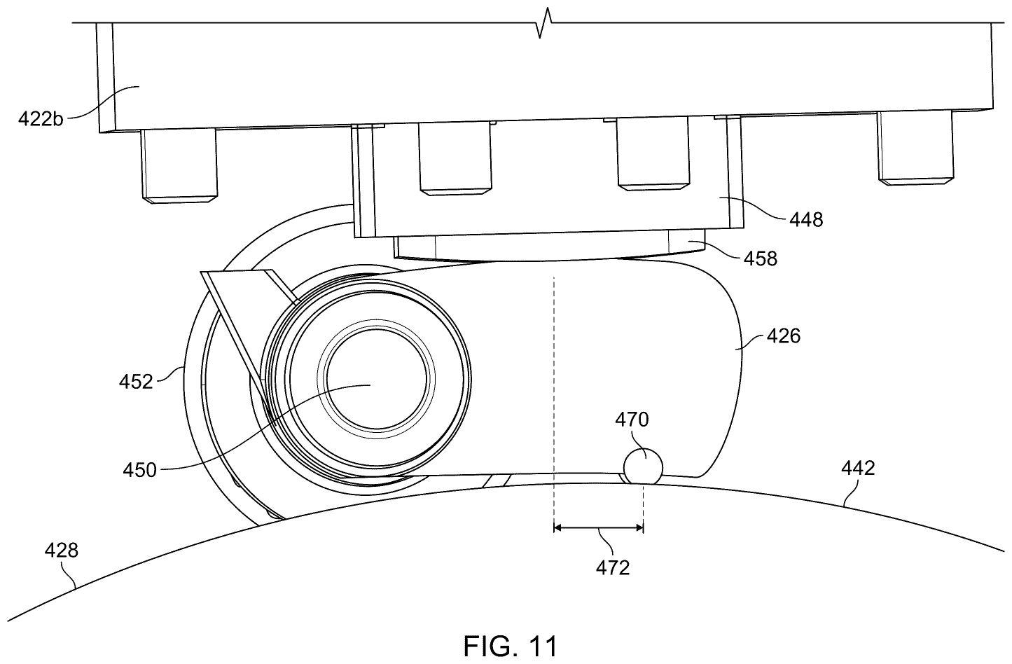

The piezoelectric elements in the holder 312 at the proximal end 324 of the piezoelectric cartridge 302 (referred to as the proximal holder) are mechanically coupled to the rotor 316. In an example, the mechanical coupling is implemented by an assembly including a rocker arm and a piston (see FIG. 11), with the rocker arm contacting the outer circumference of the rotor and the piston contacting the proximal end of the piezoelectric elements in the proximal piezoelectric holder 312. Other approaches to this mechanical coupling, such as spring-based coupling, roller-based coupling, or other suitable couplings, can also be implemented. At a distal end 326 of the piezoelectric cartridge 302, the piezoelectric elements are held in a fixed position (e.g., the distal end of the piezoelectric elements in the distal-most piezoelectric holder 312 are held at a fixed distance from a center of the rotor 316) by a cartridge adjustment mechanism 310. The cartridge adjustment mechanism 310 can be implemented as a screw, a servo motor, or other suitable mechanism.

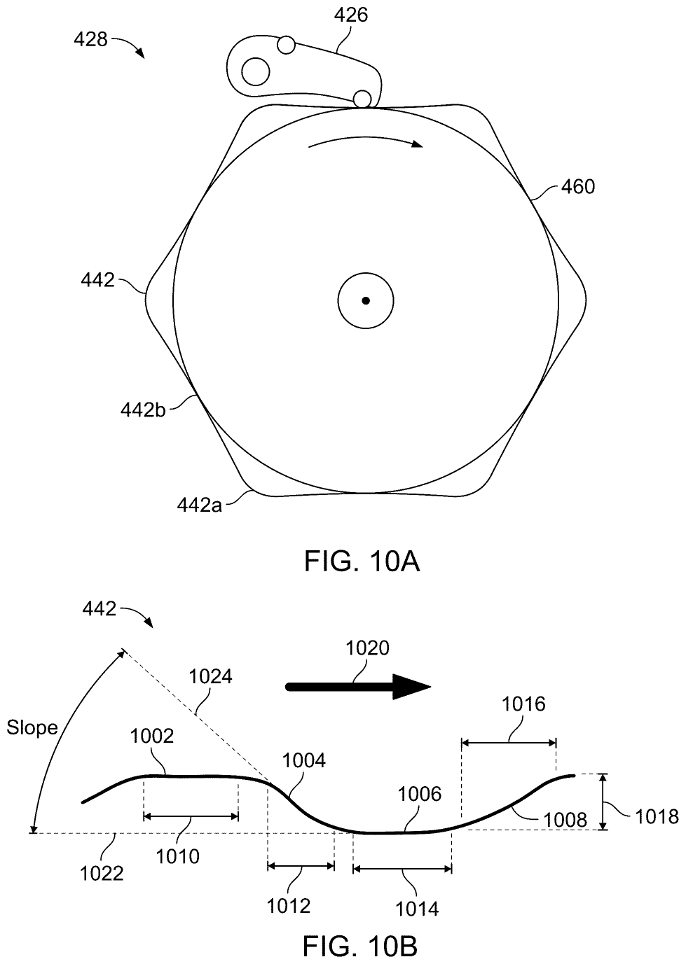

The outer circumference of the rotor 316 has cam lobes (see FIG. 10B) such that the rotor diameter varies around the circumference of the rotor 316. When the rotor 316 is rotated, the varying diameter applies a repeatedly (e.g., periodically) varying stress to the piezoelectric elements in the piezoelectric cartridge 302 via the mechanical coupling therebetween (e.g., via the rocker arm and piston). The application of this varying force compresses and decompresses the piezoelectric elements in the piezoelectric holders 312, resulting in generation of a charge in the piezoelectric elements. This charge is captured as repeating (e.g., periodic) voltage pulses that are harvested by an energy harvesting system (e.g., energy harvesting system 104). In specific examples, the repeated stress applied to the piezoelectric elements can be greater than 150 pounds per square inch, e.g., between 150 and 10,000 psi or between 3000 and 6000 psi, e.g., 500 psi, 1000 psi, 2000 psi, 3000 psi, 4000 psi, or 5000 psi.

Notably, the output voltage of a given piezoelectric element is a function of the pressure applied. Output voltage on both compression and relaxation of an element tends to increase as the compression pressure is increased. Ultimately, the peak output voltage of a given piezoelectric element is dependent upon its intrinsic characteristics, such as shape, size, crystalline structure (discussed below); and the compressive force applied including both peak compressive force and the pre-load pressure applied by a generator.

In some implementations, a timing disk 308 is mounted to the drive shaft 304 coaxially with the rotor 316. The timing disk 308 includes indicators 322 that are aligned with repeated (e.g., periodic) variations in the diameter of the rotor 316. The power generation system 300 can include an optical sensor to detect the indicators 322. The optical sensor can be coupled to a timing system that is operable to time electronic circuits to capture power generated by the piezoelectric cartridge 302.

### Multiple Cartridge Piezoelectric Generator

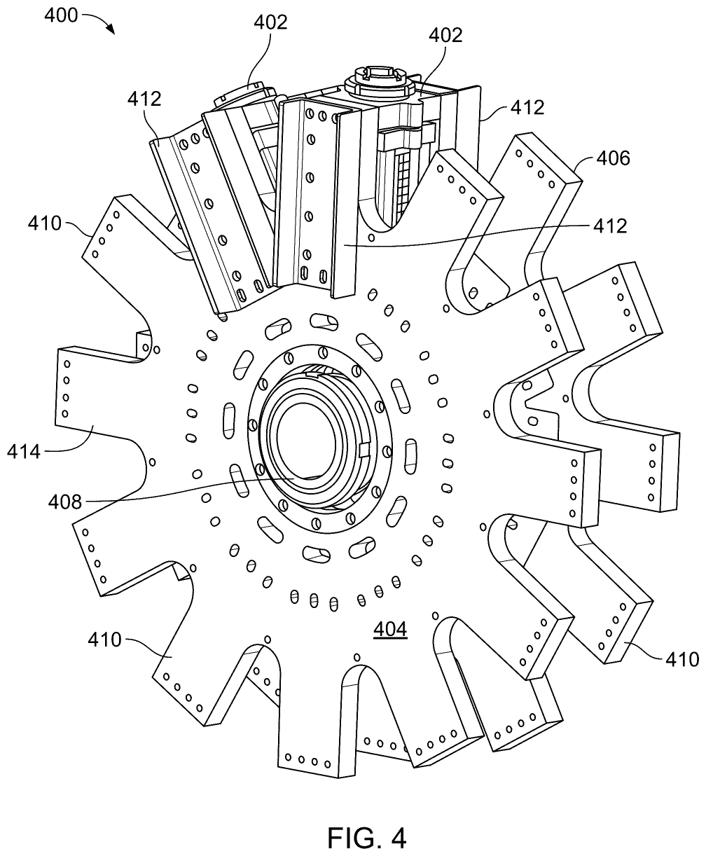

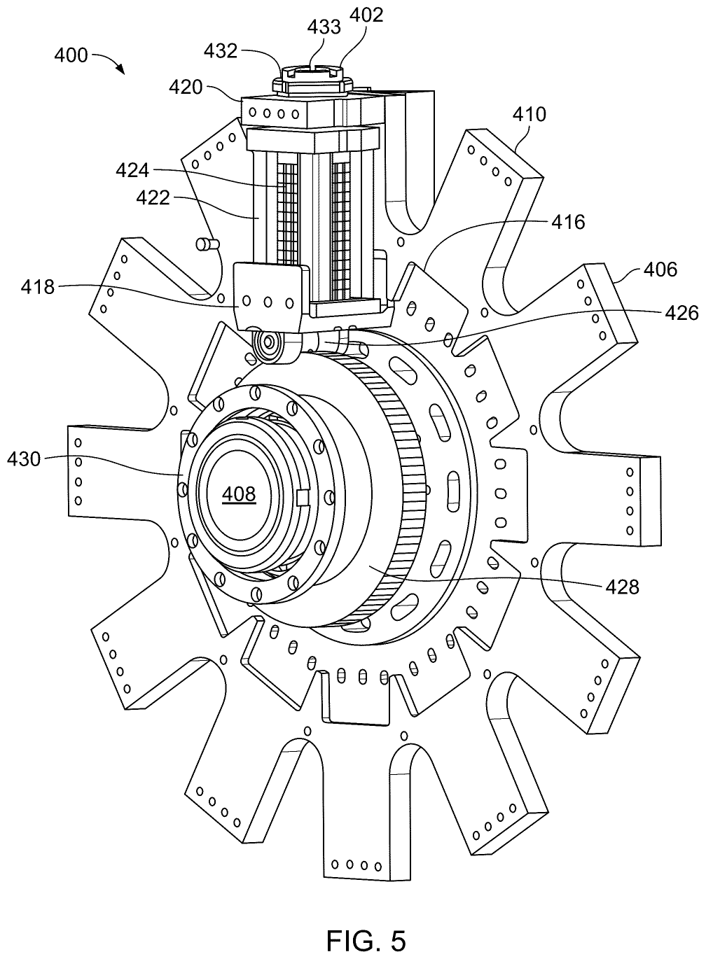

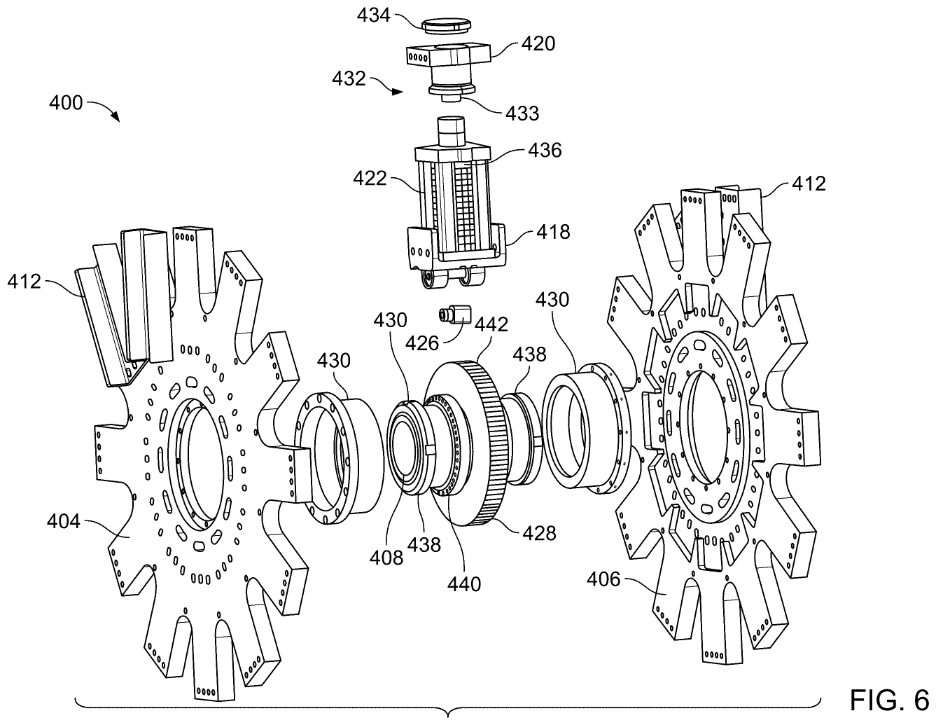

FIG. 4 is a perspective view of an example piezoelectric power generator 400 including multiple piezoelectric cartridges 402 extending radially from a central rotor 428. FIG. 5 is a perspective view of the piezoelectric generator 400 with front cover 404 removed. FIG. 6 is an exploded view of the piezoelectric generator 400. The piezoelectric power generator 400 includes capacity to accommodate 12 piezoelectric cartridges 402; however, only 2 piezoelectric cartridges 402 are shown in FIG. 4. FIGS. 5-6 show only one piezoelectric cartridge 402 for clarity; the other piezoelectric cartridges of the power generator are similarly structured. In other implementations, more or fewer piezoelectric cartridges can be present in a piezoelectric power generator (e.g., 1 cartridge (as illustrated in FIGS. 3A-3B), 2 cartridges, 3 cartridges, 4 cartridges, 5 cartridges, 6 cartridges, 8 cartridges, 10 cartridges, etc.). Including multiple piezoelectric cartridges 402 in the piezoelectric power generator 400 enables increased power output for the same or similar energy input. As discussed above for the piezoelectric generator of FIGS. 3A-3B, the piezoelectric power generator 400 can be oriented horizontally such that the rotor 428 lies in a horizontal plane (or substantially horizontal plane) and each of the piezoelectric cartridges 402 extends horizontally from the rotor 428.

The piezoelectric power generator 400 includes a front cover 404, a back cover 406, and a drive shaft 408. The front cover 404 and back cover 406 are structured to support and align the piezoelectric cartridges 402 relative to the rotor 428 and drive shaft 408. The front cover 404 and the back cover 406 have radial arms 410 on which the piezoelectric cartridges 402 are mounted. The front and back covers 404, 406 each include recesses 416 (shown for the back cover 406 in FIG. 5) radially aligned with respective radial arms 410. The recesses 416 are sized to accommodate an inner bracket 418 of the corresponding piezoelectric cartridge 402 to secure the piezoelectric cartridge in place. The inner bracket 418 can be fastened to the back cover, for example, by bolts, screws, rivets, clamps, welds, or other types of mechanical fasteners. Additional structural support for the piezoelectric cartridges 402 is provided by support elements 412 attached to an outer face 414 of the front cover 404 and/or the back cover 406. The support elements 412 can be, for example, c-channels, rectangular tubing, solid blocks of material, right-angle supports, etc. The front cover 404, the back cover 406, and the support elements 412 provide structural rigidity to enable load transfer from the rotor 428 to the piezoelectric cartridges 402 (e.g., via mechanical compression) with minimal elongation of the front cover 404, back cover 406 and support elements 412.

Each piezoelectric cartridge 402 includes a housing 422 secured to the corresponding inner bracket 418 at the proximal end of the piezoelectric cartridge nearest the drive shaft 408. In the example of FIGS. 4-6, the housing 422 of each piezoelectric cartridge is secured to the corresponding radial arm 410 via an outer bracket 420 at the distal end of the piezoelectric cartridge. The outer bracket 420 is attached to the front and back covers 404, 406 by mechanical fasteners (e.g., bolts, screws, rivets, clamps, welds, etc.). In some examples, the piezoelectric cartridges 402 extend radially outward beyond the extent of the radial arms 410, and the outer brackets 420 secure intermediate portions of the cartridges 402 to the radial arms 410.

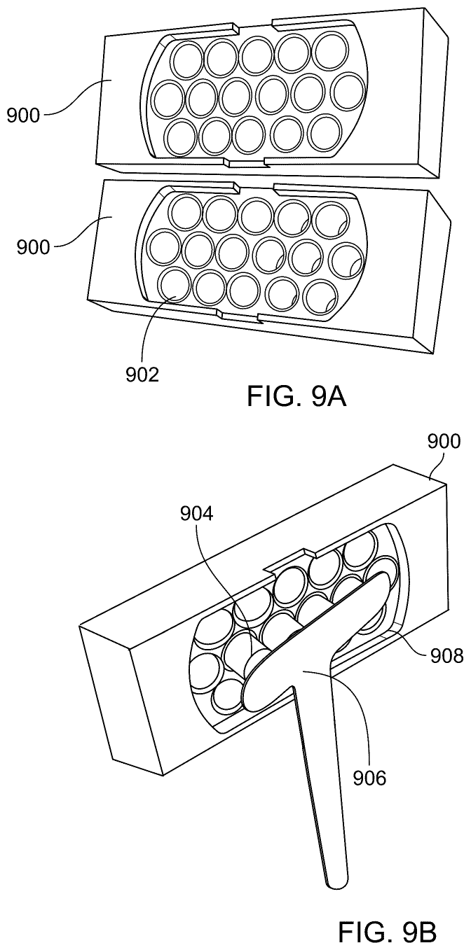

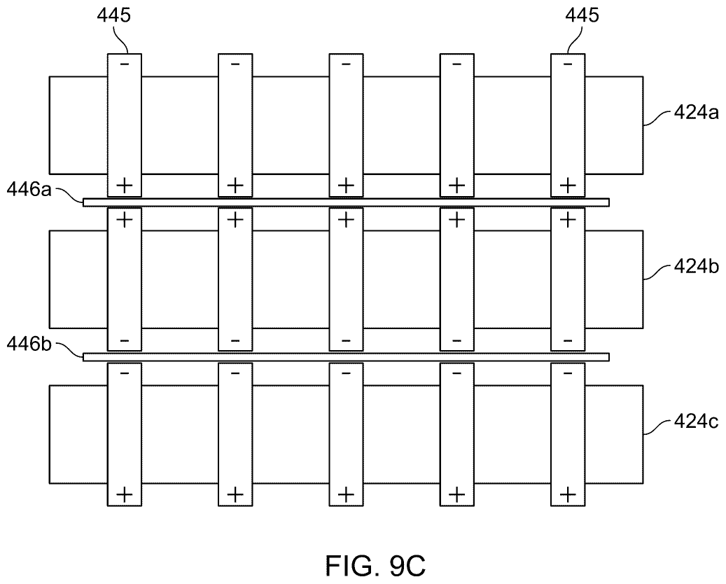

Each housing 422 can contain one or multiple piezoelectric holders 424 disposed consecutively in a stack along the length of the housing 422. Each holder 424 houses one or more piezoelectric elements, such as elongated (e.g., cylindrical) piezoelectric elements. The piezoelectric elements in each holder are arranged in parallel with the long axis of each element oriented along the radially extending axis of the housing 422. The holders 424 are disposed consecutively along the length of the respective housing such that the piezoelectric elements in consecutive holders 424 are aligned end-to-end along the length of the housing 422. An electrical contact (e.g., shown in FIG. 9B) is disposed between each pair of consecutive holders and contacts the ends of the piezoelectric elements in the pair of holders.

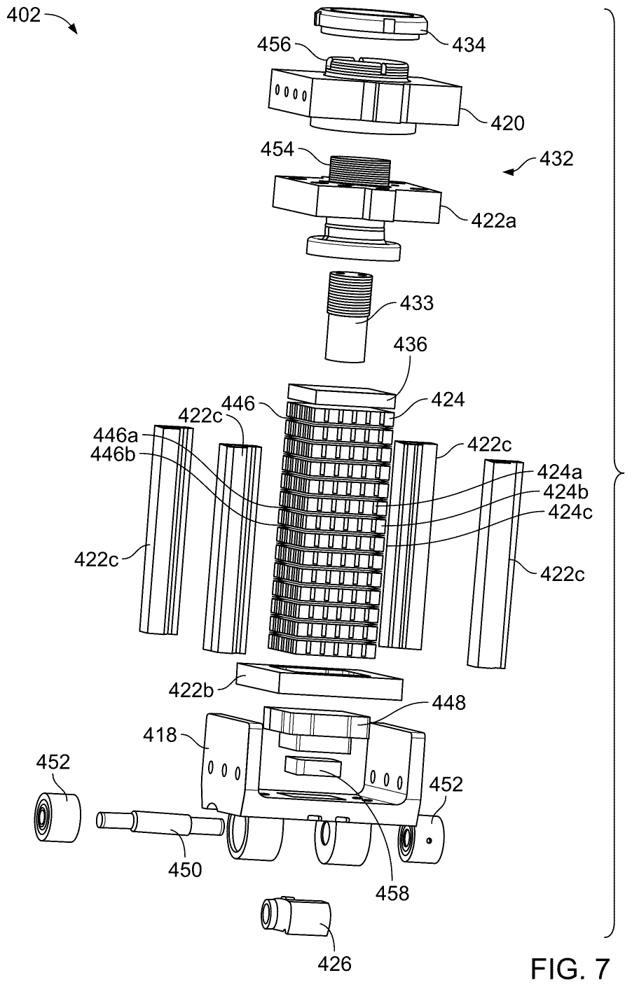

In some examples, each piezoelectric cartridge 402 can contain between 100 to 1200 piezoelectric elements. For instance, in an example depicted in FIG. 7A, holders 424 can be configured to each hold 100 piezoelectric elements arranged in a 10×10 configuration. In some implementations, a piezoelectric generator 400 can be operated with a single 10×10 bank of piezoelectric elements in each cartridge 402. In some implementations, a piezoelectric generator 400 can be operated with a stack of 10×10 banks of piezoelectric elements in each cartridge 402. For instance, a cartridge 402 can be sized to hold a stack of 1 to 12 (or more) holders 424, yielding 100 to 1200 piezoelectric elements per cartridge 204.

The piezoelectric elements in each piezoelectric cartridge 402 are mechanically coupled to the rotor 428 via a corresponding coupling assembly, e.g., an assembly including a rocker arm 426 and piston (not shown) attached to the inner bracket 418 of the respective piezoelectric cartridge. Each rocker arm 426 and piston assembly includes a rocker arm that contacts the outer circumference of the rotor 428 on one end and contacts a piston at an opposite end (see FIG. 11). Each piston exerts a force on the proximal surface of those piezoelectric elements contained in the proximal holder 424 of the corresponding piezoelectric cartridge 402. As described above for the piezoelectric generator 300, other approaches to the mechanical coupling between piezoelectric elements and rotor can also be implemented, such as spring-based or roller-based couplings.

The rotor 428 is mounted on the drive shaft 408 such that rotation of the drive shaft 408 causes rotation of the rotor 428. The outer circumference of the rotor 428 has lobes 442 such that the rotor diameter varies (e.g., periodically) around the circumference of the rotor 428. As the rotor 428 rotates, each rocker arm 426 follows the varying diameter of the rotor 428, driving a radially inwards and outwards motion of the corresponding piston 448. The rocker arm 426 operates as a class 2 lever between the rotor lobes 442 and the piston 448 to provide a mechanical advantage in compressing the piezoelectric elements. As will be described below, the various characteristics of the rocker arm 426 can be adjusted to optimize the operation of the piezoelectric generator 400. Specifically, when a given rocker arm 426 is in contact with a peak of the undulating circumference of the rotor 428 (e.g., a region of maximum diameter), the rocker arm 426 exerts a radially outward force on the corresponding piston, which in turn exerts a compressive stress on the piezoelectric elements in the corresponding piezoelectric holder 424. As the rotor rotates such that the rocker arm 426 is in contact with a valley of the undulating circumference of the rotor 428 (e.g., a region of minimum diameter), the force exerted on the piston is released and the piezoelectric elements decompress. Each compression and decompression of the piezoelectric elements causes accumulation of electrical charge across the elements, which can be captured and converted to electrical power twice per compression/decompression cycle.

A baseline compressive force between the piezoelectric elements in each cartridge 402 and the rotor 428 is controlled by a cartridge adjustment mechanism 432 at the distal end of each cartridge 402. In the example of FIGS. 4-6, the cartridge adjustment mechanism 432 includes an adjustment screw 433 threaded through the outer bracket 420 and a compression block 436 contacting the distal surface of the piezoelectric elements in the outermost holder 424. The adjustment screw 433 is configured to apply a compressive force against the compression block 436, which is in turn transferred to the piezoelectric elements in the cartridge, e.g., to apply a baseline compressive force to the piezoelectric elements. A ring 434 allows the adjustment screw 433 to extend through the outer bracket 420 to facilitate tightening or loosening of the screw. In some examples, the cartridge adjustment mechanism is an automated adjustment mechanism, e.g., implemented at least in part by a servo motor.

The adjustment screw 433 can be tightened or loosened to adjust the baseline compression applied to the piezoelectric elements by the compression block 436. For instance, the adjustment screw 433 can be adjusted to increase the baseline compression (e.g., a compressive stress without the additional stress applied by the rotor peaks). Application of a baseline compression to the piezoelectric elements can facilitate optimization of power generation and/or operating lifetime of the piezoelectric elements. In some examples, the adjustment mechanism can be periodically adjusted to maintain a target baseline compression. In some examples, when the cartridge adjustment mechanism is implemented as an automated adjustment mechanism such as a servo motor, the cartridge adjustment mechanism can constitute part of a closed loop feedback loop that continually monitors and adjusts the baseline compressive force on the piezoelectric elements.

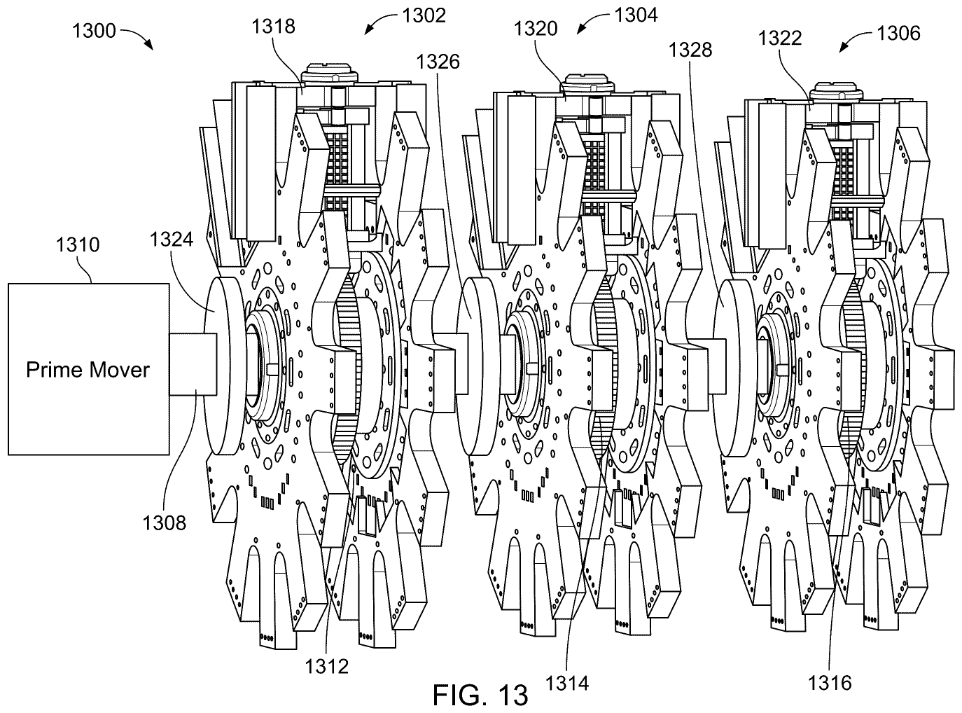

A hub 430 attaches to the front cover 404 and the back cover 406. The drive shaft 408 protrudes through the hub 430. The hub 430 supports the drive shaft 408 and allows the drive shaft 408 and the rotor 428 to rotate while the front cover 404, the back cover 406 and the piezoelectric cartridges 402 remain stationary. Endcaps 438 are attached to each end of the drive shaft 408 to prevent axial motion of the drive shaft 408 and rotor 428 relative to the front cover 404 and the back cover 406. Bearings 440 allow the drive shaft 408 to rotate within the hub 430 with decreased friction. A flywheel (not shown) can be attached to the drive shaft to smooth fluctuations in the rotation of the drive shaft 408 and rotor 428. The flywheel can be included on the outside of the front cover 404 or back cover 406 (see FIGS. 3A, 3B, and 13). Alternatively, the flywheel can be included between the front cover 404 and the back cover 406.

FIG. 7 is an exploded view of an example piezoelectric cartridge 402. The housing 422 of the piezoelectric cartridge 402 includes an outer plate 422a, an inner plate 422b and corner supports 422c. The outer plate 422a is attached, e.g., removably fastened, to distal ends of the corner supports 422c. The inner plate 422b is attached, e.g., removably fastened, to proximal ends of the corner supports 422c. Removably fastened includes, for example, being fastened with mechanical fasteners such as bolts, nuts, screws, rivets, etc. that can be removed to disassemble or partially disassemble the housing 422. In some examples, the housing 422 is constructed of a single, integral piece.

The stack of piezoelectric holders 424 extends between the inner plate 422b and the outer plate 422a. The corner supports 422c of the housing align the holders 424 (and thus align the piezoelectric elements contained in the holders) and reduce lateral movement of the holders 424. Each holder 424 houses one or more piezoelectric elements in an end-to-end orientation along the length of the cartridge 402.

An electrode plate 446 is disposed between each pair of consecutive holders 424. Each electrode plate 446 is in physical and electrical contact with the piezoelectric elements in the corresponding pair of holders. The piezoelectric elements in the holders 424 are arranged in an alternating fashion such that the ends of the piezoelectric elements contacting a same electrode plate (e.g., the piezoelectric elements in holders 424a, 424b contacting an electrode plate 446a) have a same polarity (e.g., positive or negative polarity). With this arrangement, every other electrode plate 446 is a positive electrode, and the intervening electrode plates are negative electrodes. For instance, if electrode plate 446a is a positive electrode connected to the positive polarity ends of the piezoelectric elements in the holders 424a, 424b, electrode plate 446b is a negative electrode plate connected to the negative polarity ends of the piezoelectric elements in the holders 424b, 424c.

Force is transferred from the rotor to the piezoelectric elements in the cartridge 402 by the rocker arm 426 and a piston 448. The piston 448 exerts a force on the innermost electrode plate 446 that is in contact with the piezoelectric elements in the innermost holder 424. The piston 448 is disposed in an aperture in the inner plate 422b, which is attached to the inner bracket 418, for example, by bolting or screwing the inner plate 422b to the inner bracket 418. The piston 448 distributes force from the rocker arm 426 to compress the piezoelectric elements in the cartridge 402. An intermediate block 458 that is smaller than the piston 448 passes through an aperture in the inner bracket 418 to transfer displacement and force from the rocker arm 426 to the piston 448. The aperture in the inner bracket 418 is large enough for the intermediate block 458 to pass through but not large enough for the piston 448 to pass through. The piston 448 is constrained to be between the distal surface of the inner bracket 418 and the proximal most holder 424. In some examples, a portion of the piston 448 can protrude through the aperture in the inner bracket 418, and the piston 448 can include a recess sized to receive the intermediate block 458. In some implementations, the intermediate block 458 and the piston 448 can be formed in one piece. For example, the piston 448 can be formed with a T-shaped cross-section such that an extension portion having a smaller dimension can extend through the aperture in the inner bracket 418.

In some examples, an electrically isolating plate (e.g., a ceramic plate made from yttria stabilized zirconia (YTZP)) is positioned between the piston 448 and the proximal most holder 424 to electrically isolate the piston 448 from the piezoelectric elements in the holder 424. In other examples, the piston 448 can be made from an electrically insulating material avoiding the need for an electrically isolating plate.

The rocker arm 426 is attached to the inner bracket 418 on the proximal side of the inner bracket 418. An axle 450 is supported by bearings 452 that allow the axle 450 to rotate with respect to the inner bracket 418. The rocker arm 426 is attached to the axle 450. When assembled on the piezoelectric generator 400, the rocker arm 426 is in contact with the rotor 428. As the rotor 428 rotates, the rocker arm 426 pivots on the axle 450 as the rocker arm 426 follows the lobes 442 of the rotor 428. As the rocker arm 426 pivots toward the inner bracket 418, the rocker arm 426 applies force to the intermediate block 458, which transfers the force to the piston 448 to compress piezoelectric elements in the holders 424.

The compression block 436 is disposed within the housing 422 between the outer plate 422a and the stack of holders 424. The compression block 436 is in contact with the distal most electrode plate 446. The compression block 436 is configured to evenly distribute force from the cartridge adjustment mechanism 432 to the holders 424. The compression block 436 can also provide electrical isolation between the housing 422 and the piezoelectric elements in holder 424 to reduce the likelihood of causing a short or electrical arcing in the cartridge 402. In some implementations, a silicon putty is also applied on and/or between holders 424 to provide additional arc suppression.

In general, the cartridge adjustment mechanism 432 is configured to permit either adjustment of the pre-load pressure (e.g., the baseline compression) on the piezoelectric elements or the position of the cartridge relative to the rotor, or both. Preferably, the pre-load pressure on the piezoelectric elements is just slightly greater than zero in order to prevent gaps between the piezoelectric elements when the compression/decompression cycle is in a decompression phase. If insufficient pre-load pressure is applied to the piezoelectric elements, the piezoelectric elements can impact one another between successive compression and decompression cycles causing damage to the piezoelectric elements and reducing the operation life of the elements. In addition, by permitting adjustment of the distance of the cartridge relative to the rotor, an entire stack of piezoelectric elements can be engaged and disengaged from the rotor, such as during start-up or if a fault is detected in a particular cartridge.

In the embodiment of FIG. 7, the cartridge adjustment mechanism 432 includes adjustment screw 433, threaded tubes 454, 456, and ring 434. Threaded tubes 454, 456 each includes a flange on the proximal end and include threads on the inside of the tube and threads on the outside of the tube. The flange end of threaded tube 454 is attached to (e.g., bolted, screwed, riveted) the proximal side of the outer plate 422a. The threaded tube 454 protrudes through an opening in the outer plate 422a. The inner diameter and inner threads of the threaded tube 454 are sized to engage the adjustment screw 433. Rotation of the adjustment screw 433 will cause translation of the adjustment screw 433 within the threaded tube 454 to increase or decrease pressure on the compression block 436. The flange of the threaded tube 456 contacts the outer bracket 420. The threaded tube 456 protrudes through an opening in the outer bracket. The ring 434 threads onto the outer threads of the threaded tube 456 to secure the threaded tube 456 in relation to the outer bracket 420. The inner diameter and the inner threads of the threaded tube 456 are sized to receive the outer threads of the threaded tube 454. The outer bracket 420 is connected to the outer plate 422a by the threaded tubes 454, 456.

The distance between the outer plate 422a and the outer bracket 420 is adjustable via the threaded tubes 454 and 456. For instance, the distance between the outer plate 422a and the outer bracket 420 can be adjusted to control the amount of pressure applied to the piezoelectric elements during operation of the piezoelectric generator 400, assuming adjustment screw 433 remains fixed. With adjustment screw 433 fixed, for example, increasing the distance between the outer plate 422a and the outer bracket 420 increases the pressure applied to the piezoelectric elements (via screw 433 and compression block 436), while decreasing the distance decreases the applied pressure. A minimum pressure exerted on the piezoelectric elements is the baseline compressive stress.

The adjustment screw 433 enables further or additional adjustment of the baseline compressive stress applied to the piezoelectric elements in holders 424, to e.g., preload the piezoelectric elements. As noted, typically, a baseline compressive stress is large enough to prevent gaps between the piezoelectric elements in the holders 424 when the compression/decompression cycle is in a decompression phase (e.g., when the cartridge 402 is aligned with a valley of the rotor 428 circumference). If insufficient baseline compressive stress is applied to the piezoelectric elements in the cartridge 402, the piezoelectric elements within the cartridge 402 can impact one another between successive compression and decompression cycles, causing damage to the piezoelectric elements and reducing the operation life of the elements. The adjustment screw 433 can include a recess in the distal end of the adjustment screw to facilitate rotating the adjustment screw 433. The geometry of the recess can be, for example, a cross, a slot, a triangle, a square, a pentagon, a hexagon, etc. Alternatively, adjustment screw 433 can be rotated by a socket shaped protrusion or similar mechanism.

In some examples, the outer bracket 420 and the outer plate 422a can be the same element. In some examples, the outer bracket 420 and the outer plate 422a can be connected via other means for example with fasteners such as bolts, screws, or rivets or by more permanent connections such as welding.

### Piezoelectric Elements

FIG. 8 illustrates example piezoelectric elements that can be used in piezoelectric generators (e.g., piezoelectric generator 400). Piezoelectric elements can have various shapes and sizes. As discussed below, the size and shape of the piezoelectric elements can affect the efficiency of power generation.

Some piezoelectric elements are cylindrical piezoelectric elements. For instance, piezoelectric elements 800, 812 are cylindrical piezoelectric elements with circular cross-section. Piezoelectric elements 800, 812 have a length that is larger than the diameter of the cylinder. Both piezoelectric elements 800, 812 have an aspect ratio (e.g., ratio of length to diameter) of greater than one; the aspect ratio of the piezoelectric element 800 is smaller than that of the piezoelectric elements 812. Piezoelectric elements 812 are cylindrical elements with a length larger than the diameter of the cylinder, e.g., such that their aspect ratio is less than one.

In some examples, the piezoelectric elements are rectangular prisms with a rectangular cross-section. For instance, piezoelectric element 802 is a rectangular prism with a length larger than the width of the rectangular prism. Piezoelectric elements 810 are individual cuboid elements with a length similar to the width of the cuboid.

Piezoelectric elements 806 are cuboid piezoelectric elements 806 cut from a solid block of piezoelectric material 804, with cuts extending through less than an entire thickness of the block 804 such that the piezoelectric elements 806 are attached at a base of the block 804. Cylindrical piezoelectric elements having circular cross-sections are often preferred to avoid stress concentrations that occur at sharp corners (e.g., as can occur in rectangular prisms).

The aspect ratio of the piezoelectric element affects the efficiency of the energy output by the piezoelectric element compared with the energy input. Generally, piezoelectric elements for use in piezoelectric generators have an aspect ratio greater than 1, e.g., 4:1 or more, 6:1 or more, or up to 10:1. A practical upper limit to the aspect ratio is dictated by the capacitance of the piezoelectric element. As the aspect ratio increases, the capacitance decreases; beyond a threshold aspect ratio (e.g., beyond an aspect ratio of 10:1), the power generation efficiency decreases.

The length of the piezoelectric elements impacts the energy available for harvesting. Available energy from a given piezoelectric element is defined by the voltage (V) across the element and the capacitance (C) of the element (e.g., energy=½ CV²). A longer piezoelectric element has a higher voltage capability for an equal force input and thus enables recovery of more energy. In some examples, the piezoelectric elements are between 0.5 inches and 2 inches in length, e.g., about 1 inch or about 1.5 inches. In some examples, the piezoelectric elements are longer, e.g., up to 6 inches or up to 8 inches in length. In some examples, the piezoelectric elements are boules having a diameter of about 12 inches and a length of about 84 inches.

For a given length of a piezoelectric element, the capacitance of the piezoelectric element increases with increasing diameter or width of the piezoelectric element. For example, increasing the diameter of a cylindrical piezoelectric element from 0.25 inches to 0.375 inches, for the same length, doubles the capacitance of the piezoelectric element.

The following table includes data for several example piezoelectric elements:

| | | | | | Piezoelectric |
|---|---|---|---|---|---|
| | | | | | Charge |
| | | Aspect | Capaci- | Voltage | Displacement |
| | Size | Ratio | tance | Output | Coefficient |
| Shape | (inches) | L/D | (nF) | (kV) | d33 |
| Cylindrical | ø 0.25 | 2.5:1 | 0.06 | Up to 15 | 400 |
| Cylindrical | ø 0.25 | 4:1 | 0.036 | Up to 20 | 400 |
| Cylindrical | ø 0.375 | 1.5:1 | 0.055 | Up to 20 | 700 |
| Cylindrical | ø 0.75 | 4:1 | 0.11 | Up to 25 | 700 |
| Square | 0.2 × 0.2 | 4:1 | 0.04 | Up to 20 | 1,100 |
| Cylindrical | ø 2.5 | 4:1 | 0.364 | Up to 25 | 4,000 |

This data includes both data based on actual testing and experiments for certain of the smaller elements and extrapolated data for the larger elements.

In some implementations, the piezoelectric elements can be crystals. Piezoelectric crystals include single crystalline material and polycrystalline material. Single piezoelectric crystals are known in the art and can be formed by growing. A polycrystalline piezoelectric material typically includes multiple crystalline regions separated by grain boundaries. These materials can be formed by sintering a precursor powder material. Generally, single crystal piezoelectric elements produce more energy for a given input force than a polycrystalline piezoelectric element, although polycrystalline piezoelectric elements can be easier to manufacture than single crystal piezoelectric elements. Polycrystalline piezoelectric elements may be less expensive than single crystal piezoelectric elements and/or more readily available for purchase. This description sometimes refers to “piezoelectric crystals,” which encompasses both single crystal and polycrystalline piezoelectric elements.

Piezoelectric elements for the piezoelectric generators described here can be made from a variety of piezoelectric materials, including lead-based or non-lead-based materials. Examples of piezoelectric materials include lead magnesium niobate-lead titanate (PMN-PT), lead magnesium niobate-lead zirconate titanate (PMN-PZT), barium titanate (BaTiO₃), barium calcium titanate (BCT), barium zirconate titanate (BZT), potassium niobate (KnbO₃), sodium tungstate (Na₂WO₃), bismuth titanate (Bi₄Ti₃O₁₂), and sodium bismuth titanate (NaBi(TiO₃)₂). The energy density of the material used in the piezoelectric generators described here can be at least about 300 μJ/cm³, e.g., 400 μJ/cm³, 650 μJ/cm³, 700 μJ/cm³, or more.

The following table includes data for several example piezoelectric crystals having the same shape, size, and aspect ratio under the same compression and rotational frequency:

| | | | Voltage |
|---|---|---|---|
| Type | Material | d33 | Output |
| Single crystal | PMN-PT | 1,100 | 15 kv |
| Poly crystalline | PZT - 5H | 400 | 10 kv |
| Poly crystalline | PZT - 5H | 700 | 13 kv |

This data includes both data based on actual testing and experiments for certain crystals and extrapolated data for other crystals.

FIGS. 9A-9B show example holders 900 to hold piezoelectric elements 904 in a piezoelectric generator (e.g., piezoelectric power generator 400). Each holder 900 includes multiple openings 902 sized and shaped to receive piezoelectric elements 904. The openings 902 are sized to prevent lateral movement of the piezoelectric elements 904 and maintain registration of the piezoelectric elements 904 in consecutive holders. For example, the openings 902 can be dimensioned with a locational clearance fit or a transition fit based on the diameter of the piezoelectric elements 904. A locational clearance fit allows assembly without application of force and provides a snug fit. During compression, the piezoelectric elements 904 increase in diameter (e.g., forming a barrel shape that is wider around a middle portion than at the ends). The clearance between the piezoelectric elements 904 and the holders 900 accommodates the increase in diameter without inducing additional lateral pressure on the piezoelectric elements 904. For example, a piezoelectric element can expand by 0.00001 inch when experiencing a 0.002 inch compression. The opening 902 of the holders 900 would then be at least 0.00001 inch greater than the uncompressed diameter of the piezoelectric element to not induce lateral pressure on the piezoelectric element during compression.

The holders 900 are electrically insulating (e.g., electrically non-conductive) to prevent electrical contact between adjacent piezoelectric elements 904 within the same holders 900. In some examples, the holders 900 are also thermally conductive to transfer heat away from the piezoelectric elements 904. Example materials for the holders include hard plastics such as polypropylene, polyethylene, polycarbonate, bakelite, or other suitable plastics; or thermally conductive and electrically insulating ceramics including cellulose based composites, or glass. In some examples, the holders 900 can include fins or other geometries forming heat sinks that facilitate convective heat transfer away from the piezoelectric elements 904.

An electrode 906 contacts the base of the piezoelectric elements in each holder 900 and provides an electrical connection between the piezoelectric elements 904 and circuitry connecting to the energy harvesting system. The electrode 906 can be made from an electrically conductive material such as copper, aluminum, gold, graphene, silver, etc. In some examples the electrode 906 is made from a beryllium copper alloy. In some examples, the electrode 906 is also thermally conductive, e.g., to conduct heat away from the piezoelectric elements 904.

In the illustrated example, the electrode 906 is a planar electrode having a lateral extent that spans the extent of the openings 902 in the holder 900 that are occupied by piezoelectric elements 904. One side of the electrode 906 contacts the base of the piezoelectric elements in the holder 900, and the opposite side of the electrode contacts the base of the piezoelectric elements in the adjacent holder (see FIG. 9C). In some examples, multiple electrodes can be used, with each electrode contacting a subset of the piezoelectric elements 904 in each holder 900.

In the illustrated example, a recess 908 is defined on both sides of the holder 900 to accommodate the electrode 906 between consecutively stacked holders 900.

In some implementations, the piezoelectric elements 904 are arranged in the holders 900 such that all of the piezoelectric elements 904 in a given holder have the same pole orientation. For example, all of the piezoelectric elements 904 can be oriented to have their positive poles facing one side of the holder 900 and their negative poles facing the opposite side of the holder 900. In this arrangement, the electrodes 906 wire the piezoelectric elements 904 in each holder in a parallel circuit configuration. Holders 900 in a stack of holders are also wired in parallel. The parallel circuit configuration allows maximum power capture from the piezoelectric elements 904. FIG. 9C is a side view of three consecutively stacked holders 424a-c with intervening electrodes 446a-b, each holder containing multiple piezoelectric elements 445. The piezoelectric elements 445 in each holder 424 are aligned end-to-end with correspondingly positioned piezoelectric elements 445 in the adjacent holders.

The piezoelectric elements 445 in a given holder are arranged with a common polarity orientation, such that all piezoelectric elements in a same holder have their negative poles (denoted as “−” in the figure) facing one direction and their positive poles (denoted as “+” in the figure). The piezoelectric elements 445 in adjacent holders are arranged with the opposite orientation, such that negative poles of piezoelectric elements in one holder (e.g., holder 424b) face negative poles of piezoelectric elements in an adjacent holder (e.g., holder 424c) and positive poles of piezoelectric elements (e.g., in holder 424b) face positive poles of piezoelectric elements in the other adjacent holder (e.g., holder 424a). With this arrangement, each electrode 446 is electrically connected to piezoelectric elements 445 from two adjacent holders 424. For instance, the electrode 446a is wired to the positive poles of the holders 424a-b, and the electrode 446b is wired to the negative poles of the holders 424b-c.

In some examples, the piezoelectric elements in consecutively stacked holders all have the same pole orientation. For example, all of the piezoelectric elements can be oriented with the positive pole facing the same direction. In such examples, two or more electrodes are used between each pair of holders. One electrode is wired to the negative poles of the piezoelectric elements in one holder, and one electrode is wired to the positive poles of the piezoelectric elements in the other holder of the pair. An electrically insulating layer can be placed between the two electrodes to prevent undesired electrical communication.

### Rotor/Rocker Arm

FIG. 10A is a side view of an example rotor 428 for use in the piezoelectric power generator 400. The rotor 428 includes lobes 442 around the outer circumference 460 of the rotor 428 such that the diameter of the rotor 428 varies around the circumference 460 of the rotor. At peaks 442a of the lobes 442 the diameter is larger, and at valleys 442b of the lobes 442 the diameter is smaller. The height of the lobes 442 is exaggerated in FIGS. 10A and 10B for illustrative purposes. During operation of the piezoelectric generator, the rotor 428 rotates in a clockwise direction, and the lobes 442 cause the rocker arm 426 and piston to apply a repeated compression stress to the piezoelectric elements.

The spacing between the lobes 442 (e.g., the arc length of the rotor 428 subtended by a peak and a valley) can be determined based on factors including, e.g., a number of compression/decompression cycles of the piezoelectric cartridge 402 per unit time, the nominal diameter of the rotor 428, and the rotational velocity of the rotor 428. For example, for a 10-inch diameter rotor rotating at one revolution per second, the period of the lobes would be approximately 1 inch to achieve a cycle rate for the piezoelectric elements of 30 cycles per second.

FIG. 10B is a schematic of a single period of the lobes 442, including a peak 1002 and a valley 1006, with the circumference at the peak 1002 being greater than the circumference in the valley 1006. The rotational direction 1020 (to the right as pictured) specifies an incline portion 1004 and a decline portion 1008. As the rotor rotates such that the rocker arm moves from the valley 1006 up the incline portion 1004 to the peak 1002, the rocker arm is pushed circumferentially outwards into the piston, compressing the piezoelectric elements. As the rotor continues to rotate, the rocker arm moves from the peak 1002 down the decline portion 1008 and into the valley 1006 of the next lobe, releasing the compression on the piezoelectric elements.

The peak 1002 has a circumferential extent 1010 (referred to as the peak dwell distance 1010) in which the circumference of the rotor is constant. Similarly, the valley 1006 has a circumferential extent 1014 (referred to as the valley dwell distance 1014) in which the circumference of the rotor is constant. Although illustrated as flat (or mostly flat), in practice the dwell regions have a curvature (e.g., the curvature corresponding to the rotor radius) to maintain a constant force on the piezoelectric elements during the dwell distances 1010, 1014. For example, the peak dwell distance 1010 can have a curvature defined by a major radius of the rotor 428, and the valley dwell distance 1014 can have a curvature defined by a minor radius of the rotor 428.

The dwell distance affects power generation and power collection from the piezoelectric elements. The dwell distances 1010, 1014 can be determined based on the diameter of the rotor 428, the desired rotational velocity of the rotor 428, and the time needed to capture energy from the piezoelectric elements in a fully compressed state and a decompressed state. Each dwell distance 1010, 1014 corresponds to a distinct energy capture event. Energy generated from the compression is captured separately from energy generated during the decompression. In some examples, the peak dwell distance 1010 and the valley dwell distance 1014 are traversed in a different amount of time, e.g., the dwell time at the peak is different from the dwell time in the valley.

The length 1012 and slope of the incline portion 1004 and the height 1018 between the peak 1002 and the valley 1006, coupled to the rotational velocity determines the compression rate of the piezoelectric elements. The length 1016 and slope of the decline portion 1008 and the height 1018 determines the decompression rate of the piezoelectric elements. A slope angle for the inclines and declines relative to a curved rotor can be defined, e.g., by reference to a tangent line 1022 to the minor radius of the rotor at the base of an incline 1004 or decline 1008 (e.g., shown extending tangent to valley 1006 in FIG. 10B). A slope angle can be measured in reference to the tangent line 1022 and second reference line 1024 extending from a portion maximum rise/fall of an incline/decline.

In some implementations, the lengths 1012 and 1016 and corresponding slopes can be different resulting in asymmetry of the lobe 442. Asymmetry of the lengths 1012 and 1016 can be used to tailor the power generation to the electrical and structural characteristics of the piezoelectric elements during compression and decompression. For example, the piezoelectric elements may produce voltage more efficiently during compression at a higher compression rate than during decompression resulting in a steeper incline portion 1004 and a shallower decline portion 1008. The decline portion 1008 can also be less steep than the incline portion 1004 to maintain contact between the outer circumference of the rotor 428 and the rocker arm 426. For example, if the decline portion 1008 is too steep, the rocker arm may “jump” off the peak 1002, losing contact with the rotor 428. This is undesirable because it causes an uncontrolled decompression of the piezoelectric elements and may increase wear on the rotor 428 and the rocker arm 426 due to repeated impacts between the rotor 428 and the rocker arm 426 and may cause damage to the piezoelectric elements. In some examples, a spring can be added to apply downward pressure to the rocker arm to aid in maintaining contact with the rotor 428.

The height 1018 between the peak 1002 and the valley 1006 affects the amount of compression experienced by the piezoelectric elements in the piezoelectric cartridge 402. An increased compression on each individual element (resulting in a higher compression pressure) will create a higher peak output voltage for the piezoelectric elements. In addition, the amount of compression caused by the height 1018 depends on the number of holders in the piezoelectric cartridge 402. The compression of each individual piezoelectric element will be equal to the height 1018 divided by the number of consecutively stacked holders in the piezoelectric cartridge 402 and adjusted for the effective lever arm of the rocker arm 426. For example, if the height 1018 is equal to 0.03 of an inch, then for a piezoelectric cartridge with 10 consecutively stacked holders, each piezoelectric element will be compressed by 0.001 of an inch if the rocker arm 426 provides a 3:1 mechanical advantage displacing the piston 448 by 0.01 of an inch.

The height 1018 also affects the amount of input torque used to turn the rotor 428. For example, a larger height 1018 generates more compression of the piezoelectric elements increasing the normal force applied by the rocker arm 426 on the rotor 428. The increased normal force increases the friction between the rocker arm 426 and the rotor 428. The force required to compress the piezoelectric elements is non-linear, and the force required increases with the amount of compression for each piezoelectric element. For example, more force is required to compress one piezoelectric element 0.0075 of an inch than is required to compress ten piezoelectric elements 0.00075 of an inch even though the cumulative amount of compression is the same for each case.

The efficiency of the piezoelectric power generator 400 depends on many characteristics of the rotor 428 including the rotor diameter, the rotational velocity, the number of periods of the lobes 442, the dwell time at the peaks and valleys, the slope of the inclines and declines, symmetry of the period, etc. Exemplary rotor design characteristics include: Rotor Diameter: 2-24 inches; Rotational Speed: 10-500 rpm; Number of Cam Lobes: 4 to 60 lobes; Lobe Incline Slope: 10-20 degrees; Lobe Decline Slope: 20-35 degrees.

FIG. 11 is a cutaway detail view of the rocker arm 426 and piston 448. The inner bracket 418 (see FIG. 4) has been removed for illustrative purposes. The rocker arm 426 can include a follower 470 on the proximal (rotor facing) side 480 of the rocker arm 426 at the end of the rocker arm 426 opposite the axle 450. The follower 470 maintains contact with the rotor 428 and follows the lobes 442. The follower 470 contacts the rotor 428 along a transverse line that is generally aligned with the longitudinal axis of the follower 470. The diameter of the follower 470 is sufficiently large to prevent the rocker arm 426 from contacting the rotor 428. The follower 470 can include, for example, a roller bearing, or a low friction material such as a ruby coating, a sapphire coating, or a diamond coating. The rocker arm 426 maintains contact with the intermediate block 458 along the distal surface 482 of the rocker arm 426.

The rocker arm 426 and intermediate block 458 include materials that can withstand high point loads without damage. For example, the rocker arm 426 can include a hard surface (e.g., diamond) at the interface between the rocker arm 426 and the intermediate block 458 to withstand the high load transferred from the rotor 428 to the intermediate block 458 via the rocker arm 426. The weight of the rocker arm 426 can also be optimized to improve performance of the piezoelectric generator 400. For example, a lighter rocker arm 426 causes less inertial resistance to changing directions of movement thereby enabling more compression cycles per second and consequently higher energy output per second by the piezoelectric generator 400. This concept can be understood as the “un-sprung” mass of the rocker arm. For example, the term “un-sprung” mass (as used herein) refers to anything in the force train of a mechanical movement (e.g., the rocker arm and related components) that does not contribute to the development of spring force. As an example, within a cartridge 402 only the piezoelectric elements themselves develop a spring force that is released back into the system. The other moveable components (e.g., the rocker arm 426, intermediate block 458, piston 448, etc.) do not, therefore, the mass of those components limit the operating frequency. In general, the un-sprung mass of the cartridge 402 determines the upper limit on the operating frequency of the system. Decreasing the un-sprung mass enables more compression cycles per second.

In some examples, the rocker arm 426 forms a class 2 lever, which provides a mechanical multiplier facilitating energy efficient operation of the piezoelectric generator. The axle 450 acts as the fulcrum. The rotor 428 applies a force to the follower 470 at an end of the rocker arm 426. The rocker arm 426 applies a force to the intermediate block 458 and piston 448 at a location between the follower 470 and the axle 450. The mechanical advantage of the rocker arm 426 is adjustable by modifying the distance 472 between the follower 470 and the contact location between the rocker arm 426 and the intermediate block 458. Increasing the distance 472 increases the mechanical advantage, while decreasing the distance 472 decreases the mechanical advantage. Additionally, the distance 472 affects the amount of outward displacement of the piston 448. A larger distance 472 results in less displacement of the piston 448 for the same displacement of the follower 470.

When the follower 470 is in contact with a valley of the lobes 442, the rocker arm 426 exerts a minimum force on the intermediate block 458. In this position, the amount of force applied to the piezoelectric elements generally corresponds with the baseline compressive stress on the elements by the adjustment mechanism 432. When the follower 470 is in contact with a peak of the lobes 442, the rocker arm 426 applies a maximum force to the intermediate block 458.

### Additional Examples

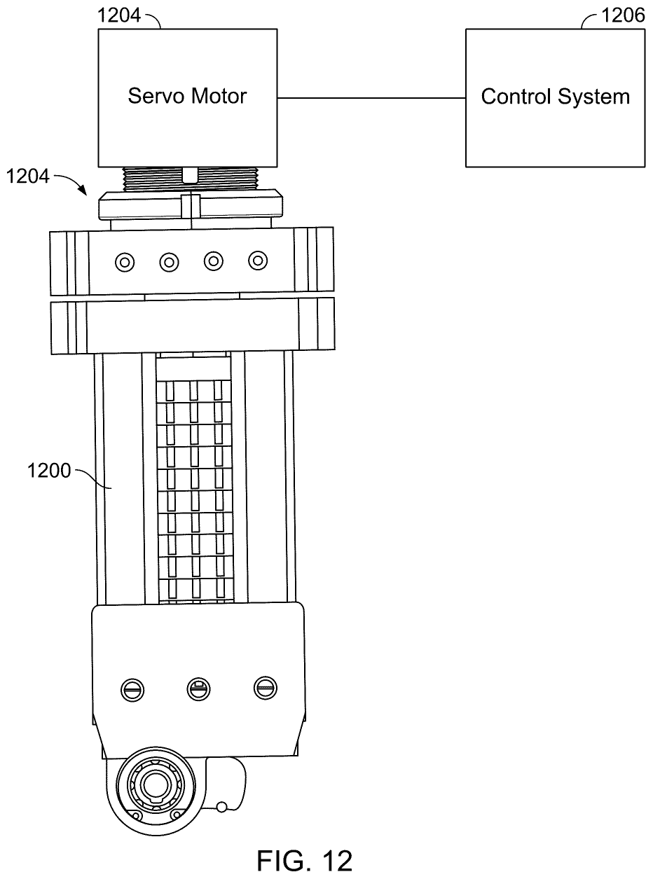

FIG. 12 is a schematic diagram of an example piezoelectric cartridge 1200 with a cartridge adjustment mechanism 1202 including a servo motor 1204. The piezoelectric cartridge 1200 is substantially similar to the piezoelectric cartridge 402. The main difference between the piezoelectric cartridge 1200 and the piezoelectric cartridge 402 is the cartridge adjustment mechanism 1202. The cartridge adjustment mechanism 1202 can be automatically adjusted by servo motor 1204 as compared with manually adjusting the cartridge adjustment mechanism 432.

The servo motor 1204 is attached at the distal end of the piezoelectric cartridge 1200. The servo motor 1204 is communicatively coupled to a control system 1206. The control system 1206 is operative to control the servo motor 1204 to adjust the pressure applied to the piezoelectric elements in the piezoelectric cartridge 1200. In some examples, the control system 1206 can use feedback control to determine an amount of compressive stress applied to the piezoelectric cartridge and adjust the amount of compressive stress applied to the piezoelectric cartridge by operating the servo motor 1204.

FIG. 13 is a perspective view of an example power generation system 1300 including multiple piezoelectric generators 1302, 1304, 1306. The piezoelectric generators 1302, 1304, 1306 are coaxially coupled to a common drive shaft 1308 such that the drive shaft 1308 causes rotation of the rotors 1312, 1314, 1316 in each of the piezoelectric generators 1302, 1304, 1306. The drive shaft 1308 is coupled to a prime mover 1310 (e.g., a rotating machine such as a turbine, engine, or other device). The prime mover 1310 causes the drive shaft 1308 to rotate thereby rotating the rotors of the piezoelectric generators 1302, 1304, 1306. As the rotors rotate, the varying diameter of the rotor causes the piezoelectric elements in the piezoelectric cartridges 1318, 1320, 1322 to repeatedly compress and decompress converting the mechanical energy generated by the prime mover 1310 into electrical energy that can be captured by an energy harvesting system.

In some implementations, the rotors 1312, 1314, 1316 can be mounted on the drive shaft 1308 such that they are angularly offset from each other. For example, lobe peaks of rotor 1314 can be offset clockwise by two degrees from the lobe peaks of rotor 1312, and the lobe peaks of rotor 1316 can be offset clockwise by two degrees from the lobe peaks of rotor 1312, assuming each rotor has sixty lobes. The offset angle can be a function of the number of rotors and the number of lobes on each rotor, e.g.,

$${α}_{offest} = \frac{360}{{L}_{per rotor} \times {N}_{rorors}} ,$$

where α_{offest} is the offset angle in degrees, L_{per rotor} is the number of lobes on each rotor, and Nᵣₒₜₒᵣₛ is the total number of rotors mounted to a driveshaft.

Flywheels 1324, 1326, 1328 are attached to the drive shaft 1308. As illustrated, there is a flywheel 1324, 1326, 1328 associated with each piezoelectric generator 1302, 1304, 1306. In some examples, a single flywheel can be used where the single flywheel provides a similar mass ratio relative to the inertial mass of the combination of all of the piezoelectric generators 1302, 1304, 1306 in the system 1300 as the mass ratio of the individual flywheels 1324, 1326, 1328 relative to the respective piezoelectric generator 1302, 1304, 1306. The size and weight of the flywheel(s) can impact operational efficiency of the generator.

Arranging multiple piezoelectric generators 1302, 1304, 1306 on a common drive shaft 1308 can reduce the complexity of the power generation system 1300 by reducing the number of prime movers needed to rotate the rotors. For example, in the power generation system 1300 a single prime mover 1310 can be sized to produce enough mechanical energy to rotate the rotors 1312, 1314, 1316 of all three generators 1302, 1304, 1306 simultaneously, rather than having 3 smaller prime movers, one coupled to each of the piezoelectric generators 1302, 1304, 1306.

The piezoelectric generators 1302, 1304, 1306 as shown are multiple arm piezoelectric generators (e.g., piezoelectric power generator 400). In some implementations, single arm piezoelectric generators (e.g., piezoelectric generator 300) can be used in the power generation system 1300. In some implementations, a combination of multiple arm piezoelectric generators and single arm piezoelectric generators can be coupled to a common drive shaft.

### Energy Harvesting System

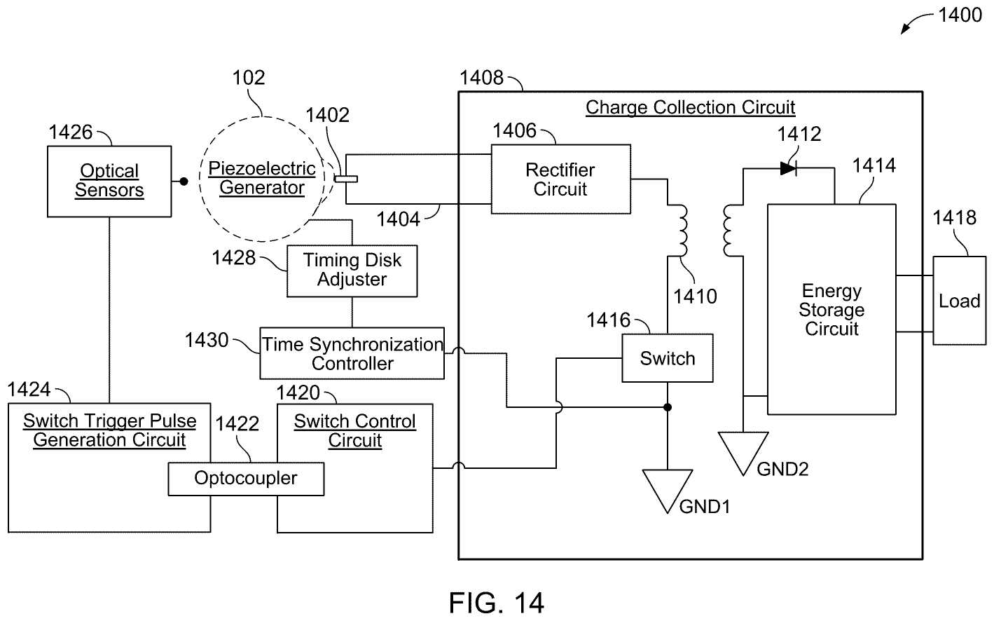

FIG. 14 is a diagram of an example energy harvesting system 1400 used for collecting energy from a power generation system. For example, the energy harvesting system 1400 can correspond to the energy harvesting system 104 (shown in FIG. 1) and can collect energy from the piezoelectric generator 102. The piezoelectric generator 102 shown in FIG. 14 is illustrated with an exaggerated cam surface (e.g., not to scale) to show how high voltage pulses are generated and built up in the piezoelectric elements 1402 by compressing and relaxing piezoelectric element(s) 1402 (e.g., the piezoelectric elements in piezoelectric cartridges 302, 402) as the cam rotates. As described in greater detail below, a switching mechanism involving switch 1416 controls the flow of current through the energy harvesting system 1400. The switch 1416, in its open state (preventing current flow through the switch), allows the voltage generated in the piezoelectric elements 1402 to build to a peak value (e.g., at least 5 kV). The switch 1416 is then closed (permitting current flow through the switch) and the piezoelectric elements 1402 act like a discharging capacitor. Current (e.g., charge driven by the high voltage) passes through the high voltage input 1404 and the rectifier circuit 1406, and then into a magnetic storage device, e.g., transformer 1410 or an inductor. This builds a high voltage potential at the windings of the transformer 1410 as a magnetic field in the core of the transformer 1410 initially resists the current. The buildup and collapse of this magnetic field causes the current to flow on the secondary side of the transformer 1410. The magnetic storage device (e.g., inductor/transformer) can be implemented as an airgap inductor or an airgap transformer.

The rectifier circuit 1406 is a component of a broader charge collection circuit 1408 that is configured to receive the current flowing from the piezoelectric generator 102 and convert it into a useful form that can be stored. In the example energy harvesting system 1400 shown in FIG. 14, the charge collection circuit 1408 includes the rectifier circuit 1406, a transformer 1410, a diode 1412, an energy storage circuit 1414, and a switch 1416.

The rectifier circuit 1406 can be a full wave rectifier that receives the current from the high voltage input 1404. The rectifier circuit 1406 maintains a constant output polarity for both pulses of the crystal output. The polarity of the high voltage input 1404 (output of the crystals) will alternate for compression and relaxation pulses. The rectifier circuit 1406 provides a constant polarity input to the rest of the charge collection circuit 1408 for both the compression and the decompression charge collection from the piezoelectric elements. This ensures a more efficient conversion compared to half-wave rectifiers which only use one half of the waveform. In some implementations, full wave rectifiers can be implemented using various configurations such as the center-tapped transformer, bridge rectifier, voltage doubler circuits, etc. Different implementations offer different advantages and can be chosen based on specific application requirements such as cost, efficiency, and size constraints.

In some implementations, transformer 1410, diode 1412, the energy storage circuit 1414, and the switch 1416 can be configured as a switched flyback transformer that enables collection of useful electrical energy from the direct current (DC) outputted by the rectifier circuit 1406. When the switch 1416 is closed, the current to the primary winding of the transformer 1410 builds up, storing energy in a magnetic field in the air gap between the primary winding and secondary winding of the transformer 1410. Upon opening the switch 1416, the sudden collapse of the magnetic field induces a voltage in the secondary winding of the transformer 1410, allowing energy transfer to the energy storage circuit 1414. The transformer 1410 can be configured such that there is a voltage step-down between the primary side input and the secondary side output, thereby converting the high voltage electrical energy originating from the piezoelectric generator 102 (e.g., 5 kV or above) into a more useful lower voltage level (e.g., 1 kV or below) for storage and usage.

The switched flyback transformer design of the charge collection circuit 1408 has many advantages. For example, it electrically isolates the energy storage circuit 1414 from the high voltage input 1404, which reduces the risk of damage to the energy storage circuit 1414. The switched flyback transformer design of the charge collection circuit 1408 also may allow for high efficiency conversion (e.g., 70% efficiency or greater) of the high voltage energy pulses from the piezoelectric generator 102 into a usable low voltage output.

The energy storage circuit 1414 can include one or more DC-DC converters connected across a storage capacitor. For example, the storage capacitor can have a capacitance at least 100 times greater than an effective output capacitance of the piezoelectric elements 1402. A load 1418 can be connected to the energy storage circuit 1414 to utilize the stored electrical energy for various applications. In some implementations, an electrical surge volume including a bank of batteries or a bank of capacitors (e.g., supercapacitors) can also be electrically connected to an output of the energy storage circuit 1414. Control circuitry can be utilized to selectively divert power outputted by the energy storage circuit 1414 to the electrical surge volume responsive to changes in electrical power demand on an electrical power network.

As previously described, the switch 1416 controls the capture of electrical energy from the high voltage input 1404 of the energy harvesting system 1400. To control this capture, the switch 1416 includes one or more control terminals that allow for triggering the switch at specific times and for specific lengths of time. The switch 1416 is a high voltage switching device such as a high voltage MOSFET (e.g., SiC, GaN, or SiN MOSFET), a diamond substrate switch, an optical transconductance varistor, other solid state switches including insulated gate bipolar transistors (IGBTs), integrated gate-commutated thyristor (IGCTs), or Thyristors), or a spark gap switch (e.g., a plasma switch such as an ignitron or trigatron switch). For example, in some implementations, the switch 1416 can include a set of switching devices connected in series, e.g., to form a voltage divider, with the control terminal (e.g., gate terminal) of each switching device controlled by a common input. Note that the terms “closed” and “open” are used to describe the conducting and non-conducting states of the switch 1416, which generally relate to mechanical switches. These terms, however, are to be considered generally synonymous with the terms “on” and “off” in reference to electronic switches, such as those discussed above. The terms “closed” and “on” refer to the conducting state while the terms “open” and “off” refer to the non-conducting state.

A switch control circuit 1420 controls operation of the switch. The switch control circuit 1420 receives triggering inputs from a switch trigger pulse generation circuit 1424. The switch control circuit 1420 and the switch trigger pulse generation circuit 1424 can be coupled to one another using an optocoupler 1422 (sometimes referred to as an opto-isolator) such that the trigger pulses generated by the trigger pulse generation circuit 1424 can be communicated with the switch control circuit 1420 to turn the switch 1416 on and off. The optocoupler 1422 electrically isolates the switch trigger pulse generation circuit 1424 (a low voltage circuit) from the switch control circuit 1420 (a high voltage circuit), thereby protecting the switch trigger pulse generation circuit 1424 from electrical damage.

In the example energy harvesting system 1400 shown in FIG. 14, the switch trigger pulse generation circuit 1424 generates trigger pulses based on inputs received from optical sensor(s) 1426. For example, the optical sensors 1426 can be configured to generate signals indicative of a positioning of the cam wheel of the piezoelectric generator 102 (e.g., the positioning of high points and low points on the cam surface). In some implementations, this can be achieved using the timing disk 308 described above in relation to FIGS. 3A-3B, which includes indicators 322 that are aligned with the variations in the diameter of the rotor 316 (e.g., corresponding to the lobes in the cam surface). In this manner, the switch trigger pulse generation circuit 1424 can determine the timings at which the piezoelectric element(s) 1402 are expected to generate high voltage pulses, and accordingly time the triggering of the switch 1416 to collect electrical energy from the high voltage pulses.

In some implementations, a timing disk adjuster 1428 can be utilized to make minor adjustments to the positioning of the timing disk 308 relative to the rotor 316 to fine tune the alignment of the disk with the rotor 316. In some cases, the timing disk adjuster 1428 can be implemented as part of the piezoelectric generator 102. To determine whether the timing disk 308 is properly aligned with the rotor 316 or needs to be adjusted, a timing synchronization controller 1430 can be included as part of the energy harvesting system 1400. The timing synchronization controller 1430 can detect, using electrical signals from the charge collection circuit 1408, whether the switch 1416 is appropriately triggered relative to the timing of the high voltage pulses generated by the piezoelectric generator 102. If there is an unexpected lag or lead time, the timing synchronization controller 1430 can cause the timing disk adjuster 1428 to adjust the positioning of the timing disk 308 so that the switch 1416 is triggered at the correct times.

The timing synchronization controller can be implemented using various well-known control schemes such as proportional (P) control, integral (I) control, derivative (D) control, PD control, PI control, and/or PID control.

While the energy harvesting system 1400 illustrated in FIG. 14 employs optical sensors 1426 to provide inputs to the switch trigger pulse generation circuit 1424, in other implementations, different inputs can also be used. For example, electronic components such as a current transformer with a bleed resistor can be used to detect when the high voltage pulses are generated by the piezoelectric generator 102 and/or when current flows through the high voltage input 1404. These detected signals can be used instead of, or in addition to, the optical signals described above as inputs to the switch trigger pulse generation circuit 1424 for timing the triggering of the switch 1416. Using detected electrical signals within the energy harvesting system 1400 to determine the timing of switch triggering can have the advantage of minimizing dependency on the mechanical tolerances of the piezoelectric generator and the mounting of the timing disk 308. As another example, electronic trigger controls can be used to measure the voltage build up at the output of the piezoelectric elements 1402 (e.g., at HV input 1404) and trigger switching pulses at a set voltage level (e.g., 10 kV, 15 kV, 20 kV).

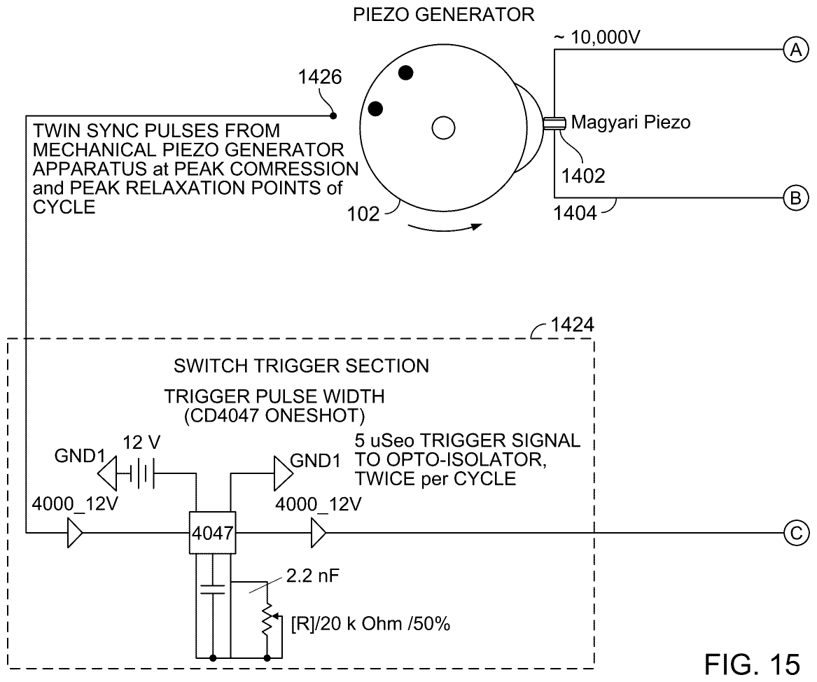

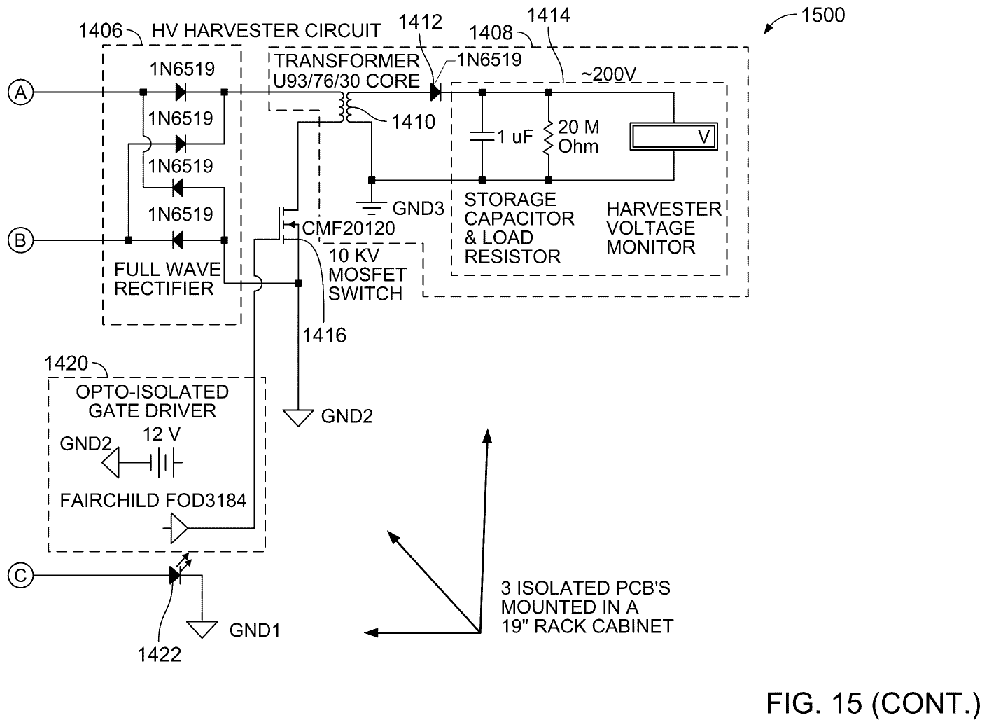

FIG. 15 shows an example energy harvesting system 1500 with additional implementation details compared to the energy harvesting system 1400 shown in FIG. 14. Similar features of the energy harvesting system 1500 and the energy harvesting system 1400 are indicated with the same reference numerals.

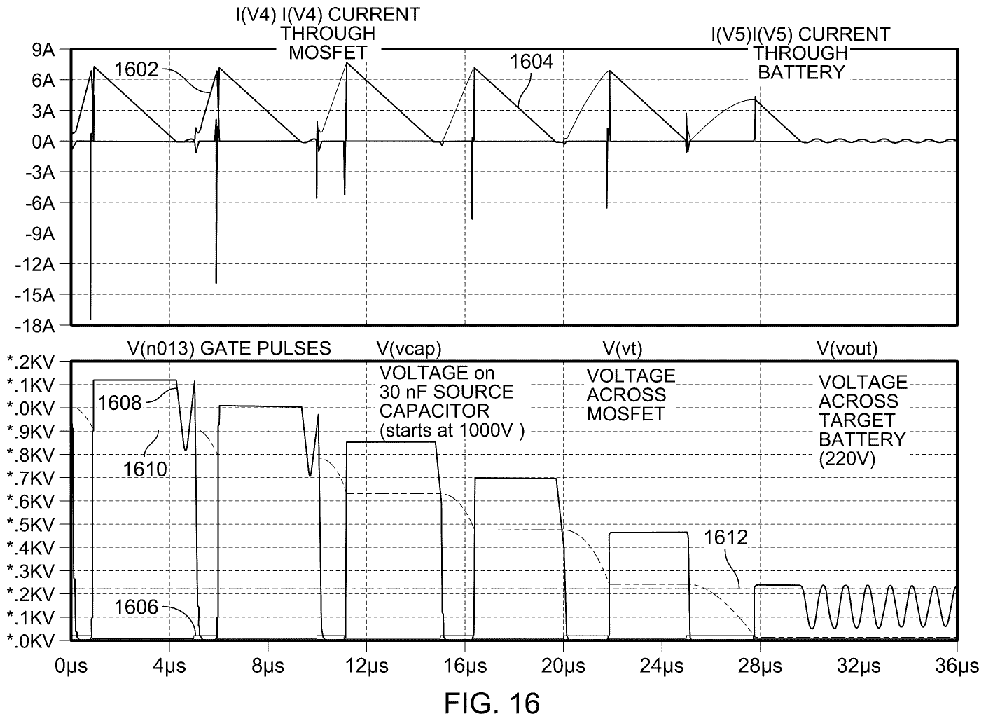

FIG. 16 shows signal timing and charge collection characteristics of an energy harvesting system such as the energy harvesting system 1500 shown in FIG. 15. Trace 1602 shows the current through the switch 1416, trace 1604 shows the current through the energy storage circuit 1414, and trace 1606 shows the trigger pulses generated by the switch trigger pulse generation circuit 1424. Trace 1608 shows the voltage across the switch 1416, trace 1610 shows the voltage across a 30 nF source capacitor on a high voltage portion of the charge collection circuit 1408, and trace 1612 shows the voltage across a battery in the energy storage circuit 1414. For illustrative purposes, the time period graphed in FIG. 16 corresponds to the charge collection from a single high voltage pulse generated by the piezoelectric generator 102. It is to be understood, however, that this process can be repeated for any number of high voltage pulses generated by the piezoelectric generator 102. For example, the piezoelectric generator 102 can be configured to repeatedly generate high voltage pulses with a period of 2 ms or less.

Each time a trigger pulse is generated (e.g., shown by an increase in voltage of trace 1606), the switch 1416 closes. When the switch 1416 is closed, the current through the switch 1416 gradually builds up and energy is stored in a magnetic field in an airgap of the transformer 1410. As shown from the trace 1604, during these periods when the switch 1416 is closed, no current flows through the energy storage circuit 1414. For example, each trigger pulse can last for a duration of 0.5 μs to 4 μs and the trigger pulses can be configured to repeat to incrementally collect charge from a single high voltage pulse. For example, in some implementations, the switch 1416 can be triggered at least six times for each high voltage pulse generated by the piezoelectric generator 102. In some implementations, successive trigger pulses corresponding to a single high voltage pulse can have increasingly long durations.

When the trigger pulse ends and the voltage of the trigger signal (trace 1606) drops down, the switch 1416 opens again. As shown from the trace 1602, when the trigger signal (trace 1606) is low and the switch 1416 is open, the current through the switch 1416 immediately drops. As such, the magnetic field in the airgap of the transformer 1410 collapses, and current begins flowing through the energy storage circuit 1414 (e.g., shown by trace 1604) to charge a battery or storage capacitor. When the current through the energy storage circuit 1414 drops below a threshold level, a trigger pulse can be generated again to collect additional charge from the high voltage pulse.

The incremental collection of charge from a single high voltage pulse can be observed from trace 1608. As seen from trace 1608, each time a trigger pulse is generated (and the switch 1416 is correspondingly closed), the voltage through the switch drops to 0 V as the electrical charge is used to store energy in the air gap of the transformer 1410. When the trigger pulse ends and the switch 1416 opens again, that magnetic field collapses and the energy is captured by the energy storage circuit 1414. As such, the voltage through the switch 1416 (e.g., shown by trace 1608) is slightly lower than it was the last time the switch 1416 was open. Through this incremental collection process, energy from the high voltage pulse can be gradually collected by the energy storage circuit 1414 using a series of trigger pulses. The incremental collection of charge from a single high voltage pulse using multiple trigger pulses may protect the electronics of the energy storage circuit 1414, reduce energy losses, and enable a reduction in the size of the transformer 1410.

The incremental collection of charge from the single high voltage pulse is also observable from trace 1610. Trace 1610 shows the voltage on a 30 nF source capacitor in a high voltage portion of the charge collection circuit 1408. The voltage on the source capacitor starts at 1000V. Then each time a trigger pulse is generated, the trace 1610 decreases to a lower voltage until there is no voltage remaining.

Through the charge collection process described above, the charge collection circuit 1408 can convert high energy pulses originating from the piezoelectric generator 102 to a steady and usable electrical energy source. For example, this is demonstrated by trace 1612, which shows that the charge collection circuit 1408 can power a battery connected to the energy storage circuit 1414 with a consistent 220V output.

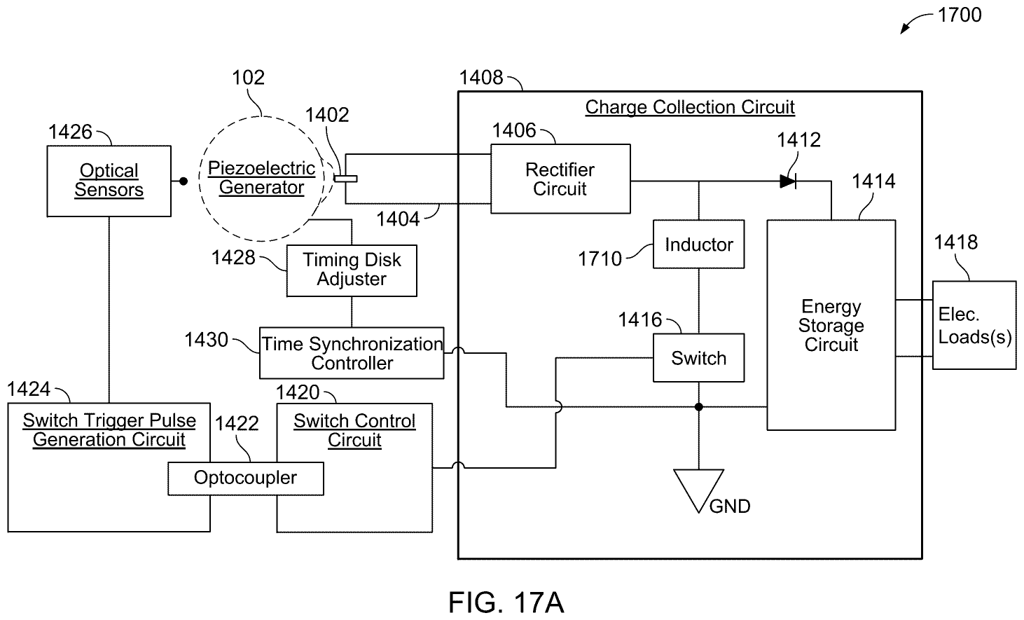

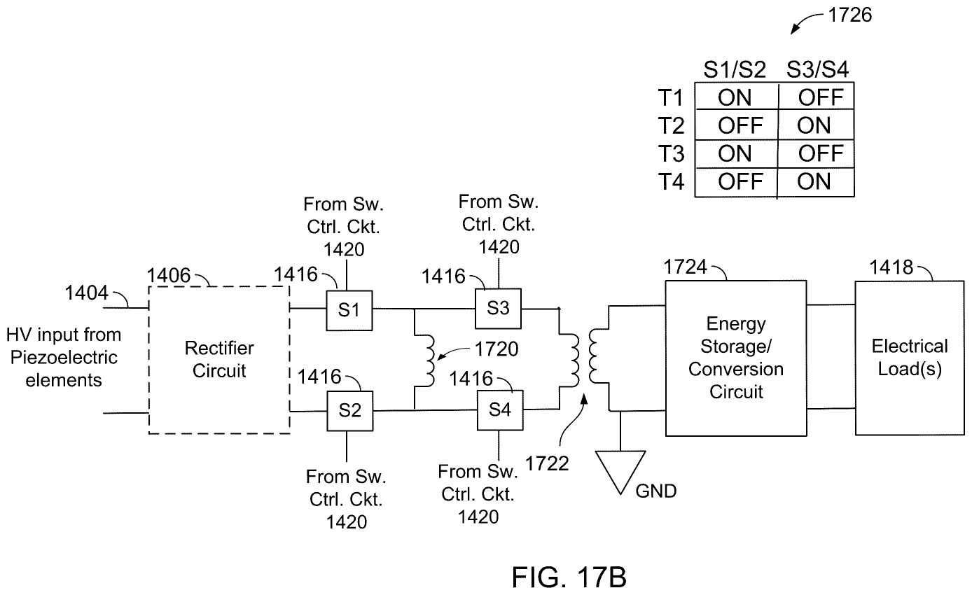

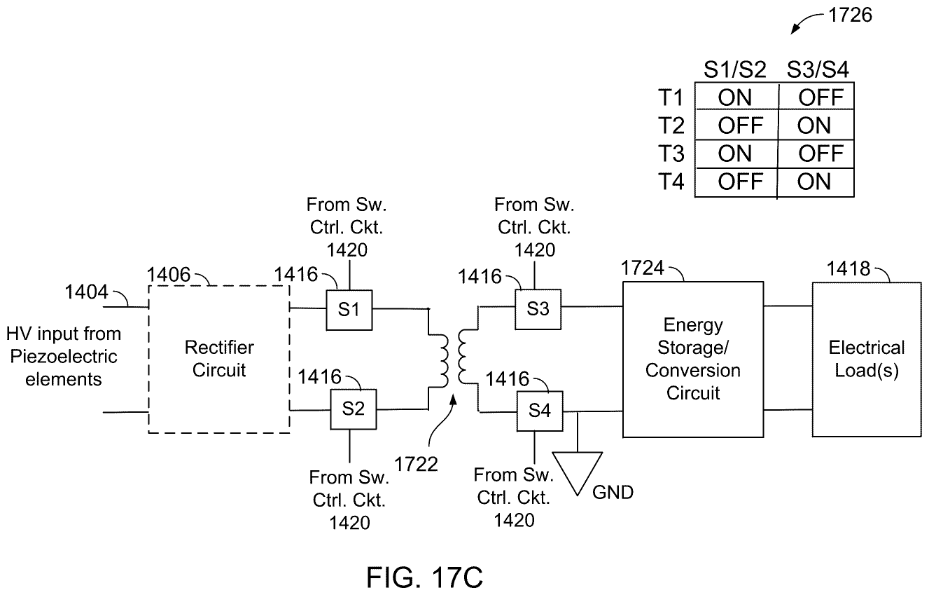

FIG. 17A shows another example of an energy harvesting system 1700. The energy harvesting system 1700 shares many similarities with the energy harvesting system 1400 shown in FIG. 14, and accordingly, similar features of the energy harvesting system 1700 and the energy harvesting system 1400 are indicated with the same reference numerals. The energy harvesting system 1700 uses an inductor 1710 rather than a transformer 1410 to couple the energy storage circuit 1414 with the rest of the charge collection circuit 1408. Like the transformer 1410, the inductor 1710 protects the energy storage circuit 1414 from the high voltage pulses originating from the piezoelectric generator. This is because when the switch 1416 is closed, the current to the inductor 1710 builds up without flowing to the energy storage circuit 1414, storing energy in a magnetic field in the air surrounding the inductor 1710. When the switch 1416 is opened, however, the magnetic field collapses, and current begins flowing through the inductor 1710 and the diode 1412 to the energy storage circuit 1414, where the charge is captured and stored.

FIGS. 17B and 17C show two alternate examples of a high voltage collection or charge collection circuit for an energy harvesting system 1700. Both circuits serve to “pump” electrical charge generated by the piezoelectric elements first to a magnetic storage device (e.g., an inductor 1720 or transformer 1722), and then to the energy storage/conversion circuit/system 1724. The static charge developed by the piezoelectric elements is converted to alternating current by the “pumping” process of high voltage switches 1416 and the magnetic storage device. The high voltage switches 1416 are operated in pairs (S1 and S2 form one pair and S3 and S4 form another pair) to “pump” the charge through the high voltage collection circuit, while also keeping the piezoelectric elements electrically isolated from the electrical loads 1418. In some implementations, a pulse transformer 1722 is used, e.g., to minimize losses from the pulses generated by the piezoelectric elements.

In some implementations, the high voltage collection circuit can include a rectifying circuit 1406 connected between the high voltage input 1404 and the first pair of high voltage switches S1, S2. Rectifying circuit 1406 is depicted in dashed lines to indicate that its use is optional. In some implementations, the rectifying circuit 1406 is located on the secondary side of transformer 1722, e.g., between the transformer 1722 and the energy storage/conversion circuit 1724.

Referring particularly to FIG. 17B, the high voltage collection circuit includes two pairs of high voltage switches S1/S2 and S3/S4. An inductor 1720 is connected between the switch pairs. For example, the one terminal of inductor 1720 is electrically connected to both the output of S1 and the input to S3 and the other terminal of inductor 1720 is electrically connected to both the output of S2 and the input to S4. The outputs of switches S3 and S4 are electrically connected to the input terminals of the primary side of transformer 1722. Control terminals of the switches 1416 are connected to the switch control circuitry 1420, which controls the operation of the switches 1416. The secondary side output of transformer 1722 is connected to the energy storage/conversion circuit 1724. In some implementations, the circuit on the primary side of transformer 1722 is ungrounded, while the circuit on the secondary side of transformer 1720 is grounded.

The circuit in FIG. 17C is similar to that in FIG. 17B except that inductor 1722 is removed. Switches S1/S2 are connected to the primary side of transformer 1722 and switches S3/S4 are connected to the secondary side of transformer 1722.

In both FIGS. 17B and 17C, the table 1726 provides a general switching sequence for the switches 1416 over two periods of operation. The switch operations are described in reference to FIG. 17B, but the switch operations are similar for FIG. 17C. Prior to time T1, the piezoelectric elements are compressed allowing voltage to build across the elements at the HV input 1404. At time T1, switches S1/S2 are closed (e.g., turned ON) allowing charge from the piezoelectric elements to pass through the high voltage input 1404, through switches S1/S2, and to the inductor 1720. As discussed above, switch operations are synchronized with the operation of the rotor 428 of the piezoelectric generator 400. For example, time T1 may correspond with a peak compression of the piezoelectric elements resulting in a peak positive charge at the high voltage input 1404. T1 occurs, and switches S1/S2 are closed, near or soon after the buildup of the peak voltage by the piezoelectric elements. Initially, inductor 1720 will resist the flow of current and develop a high voltage across it. As current begins to flow, the piezoelectric elements discharge through the inductor 1720, which stores the discharged energy in a magnetic field. The inductor 1720 serves as a temporary magnetic storage for the electrical charge as it is “pumped” through the high voltage collection circuit. Furthermore, because the piezoelectric elements act as capacitors, the inductor 1720 forms and LC circuit with the piezoelectric elements when switches S1/S2 are closed.

At time T2, switches S1/S2 are opened (e.g., turned OFF) disconnecting the piezoelectric elements from the circuit. Switches S3/S4 are closed allowing current to flow from inductor 1720 to the primary coil of transformer 1722. As the magnetic field of inductor 1720 collapses, energy is transferred to the primary side of transformer 1722 and through the transformer to the energy storage/conversion circuit 1724. The timing between T1 and T2 is based on the effective capacitance of the piezoelectric elements and the value of inductor 1720. In some implementations, switches S3/S4 are closed a short time after S1/S2 are opened, e.g., at time T2+a delay time.

At time, T3 switches S3/S4 are opened. This causes the magnetic field in the primary side of the transformer 1722 to collapse and the voltage on the transformer to reverse—creating an alternating voltage. Switches S1/S2 are also closed allowing charge from the piezoelectric elements to pass through the high voltage input 1404, through switches S1/S2, and to the inductor 1720 for the second half of a compression/relaxation cycle. For example, time T3 may correspond with a peak relaxation of the piezoelectric elements resulting in a peak negative charge at the high voltage input 1404. The energy transfer process to inductor 1720 repeats, but with an opposite polarity and current flow. In some implementations, switches S1/S2 are closed a short time after S3/S4 are opened, e.g., at time T3+a delay time.

Then at time T4, switches S1/S2 are opened disconnecting the piezoelectric elements from the circuit. Switches S3/S4 are closed again transferring stored energy from inductor 1720 to transformer 1722. In some implementations, switches S3/S4 are closed a short time after S1/S2 are opened, e.g., at time T4+a delay time.

In some implementations, a delay is inserted between each switching operation. For example, at time T2 switches S1/S2 are opened then, after a delay period, switches S3/S4 are closed. Similarly, at T3 switches S3/S4 are opened them, after a delay period, switches S1/S2 are closed. And, the process would repeat.

As shown in table 1726, the switch pairs are operated out of phase with each other so that there is never a direct electrical connection between the piezoelectric elements and the primary side of transformer (FIG. 17B) or the circuits downstream of the secondary side of transformer (FIG. 17C).

Similar to energy storage circuit 1414, the energy storage/conversion circuit 1724 converts the output of the energy harvesting system into a form that is usable by electrical loads 1418, and/or stores the output electrical energy for use by electrical loads 1418. For example, the storage/conversion circuit 1724 can include circuitry and or electronics that adjust output characteristics of the electrical power output (e.g., voltage, frequency, phase, etc.) to correspond with operating requirements of the electrical loads 1418 (e.g., to match electrical line voltage, frequency, and phase of a power grid).

In some implementations, the high voltage collection circuit can include a rectifying circuit 1406 connected between the high voltage input 1404 and the first pair of high-voltage switches S1, S2. In some implementations, the rectifying circuit 1406 is located on the secondary side of transformer 1722, e.g., between the transformer 1722 and the energy storage/conversion circuit 1724.

In some implementations, a pulse transformer 1722 is used, e.g., to minimize losses from the pulses generated by the piezoelectric elements.

In some implementations, where switches 1416 are spark gap switches, e.g., air gap plasma switches or ignitrons, switches S1 and S2 can be un-triggered or self-triggered. For example, the spark gap switches can be operated at their natural break down voltage or triggering voltage. That is, spark gap switches that have a natural break down voltage or triggering voltage below a peak voltage output of the piezoelectric elements can be selected. For instance, spark gap switches with a natural trigger voltage of about 7.5 kV can be used for piezoelectric elements that generate a 10 kV peak output voltage. In such implementations, the switches will self-trigger when the high voltage input 1404 reaches approximately 7.5 kV. As noted above, the peak output voltage of a given set of piezoelectric elements can be adjusted by changing the total compressive force applied to the elements, which is a combination of peak and pre-load pressure.

### Operational Description and Flow Charts

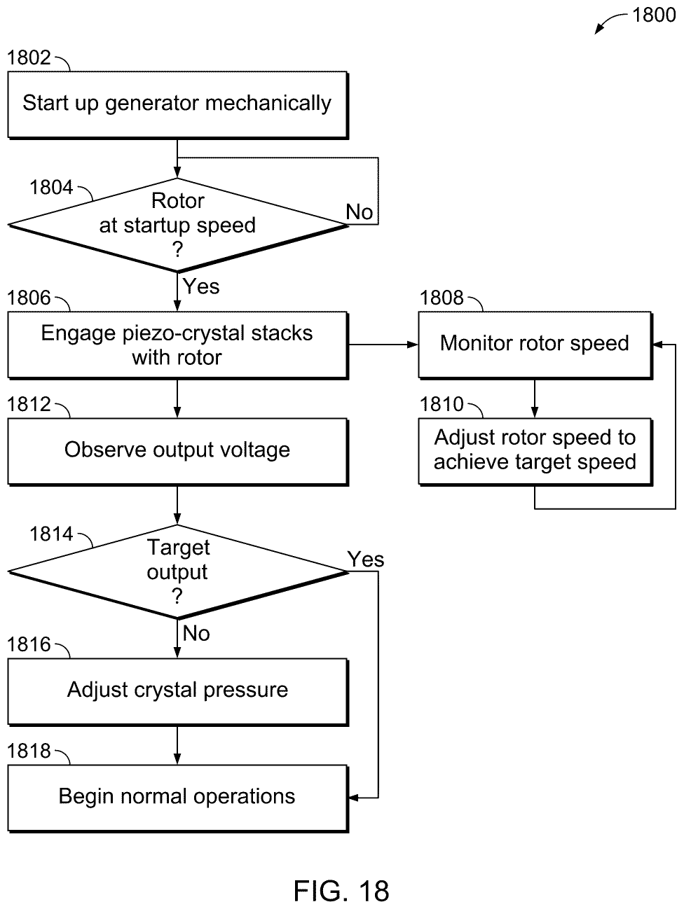

FIG. 18 is a flowchart illustrating an example process 1800 for generator startup. The process 1800 can be performed, for example, by any suitable system, environment, software, and hardware, or a combination of systems, environments, software, and hardware as appropriate. In some instances, process 1800 can be performed by the system as described in FIGS. 1-17, or portions thereof, as well as other components or functionality described in other portions of this description. In other instances, process 1800 may be performed by a plurality of connected components or systems. Any suitable system(s), architecture(s), or application(s) can be used to perform the illustrated operations. Further it should be noted that not every element of process 1800 applies to every configuration.

At 1802, the generator is started up mechanically. That is, the prime mover begins to rotate, spinning the rotor of the generator. The mechanical start up can be performed by the prime mover itself, for example, a turbine or internal combustion engine, or by another starting mechanism (e.g., an electric starter motor), that begins rotating the rotor while the prime mover establishes its own operational parameters. For example, a turbine system can gradually increase its speed as internal temperature and lubricant temperature rise to operational temperatures. During mechanical start up, one or more cartridges of piezoelectric elements can be disengaged, or at a position of minimum pressure or minimum resistance with the rotor, to allow the prime mover to “spin up” the generator. By disengaging, or decreasing pressure within the cartridge of piezoelectric elements, the initial start-up torque required to accelerate the generator to desired speed is reduced.

At 1804, a speed measurement can be performed to determine whether the rotor is at a startup speed, or above a predetermined threshold (e.g., 600 rpm, 3000 rpm, 50 rpm, or other speed) in order to accept loading. If the rotor is spinning above the predetermined threshold, process 1800 can proceed to 1806, otherwise continued speed monitoring during startup is performed. In some implementations, speed is measured using a sensor attached to the rotor, such as a hall effect sensor behaving as a tachometer. In some implementations, speed can be inferred based on other sensed signals. For example, a pressure can be measured on the cartridge of piezoelectric elements, which will oscillate according to the cam profile of the rotor. These oscillations can be used to determine rotor speed.

At 1806, once startup speed has been reached, the cartridge of piezoelectric elements can be engaged with the rotor. This can be done, for example, by actuating a servo motor for each piezoelectric cartridge, to translate the piezoelectric cartridge inwardly such that the rocker arm assembly of the piezoelectric cartridge (e.g., rocker arm assembly 426 as described above with respect to FIG. 4) applies increased pressure to the piezoelectric elements in the piezoelectric cartridge from the rotor. An example system for engaging the cartridge of piezoelectric elements is provided above and the cartridge engagement mechanism 310 is illustrated and described in FIG. 3.

At 1808, during and after the cartridge of piezoelectric elements has been engaged, the rotor speed can be continuously monitored, and adjusted in order to maintain a target speed (1810). In some implementations, this can be achieved using a closed loop control system that measures the rotational speed and adjusts the rotation of the prime mover accordingly. Such closed loop control systems can include, but are not limited to, proportional controllers, PID controllers, or other classical controllers, as well as modern control systems (e.g., LQR/LQG controllers, fuzzy logic controllers, state space systems, machine learning etc.).

At 1812, output voltage of the generator is measured. This can be measured directly by dedicated sensing circuits within each piezoelectric cartridge or inferred by other circuits. For example, the harvester voltage monitor of energy storage system 1414 (as described above with respect to FIG. 15) or the sum of multiple voltage monitors can be used to infer a voltage output of the generator.

At 1814, a determination is made whether the generator is producing a target output. This can be measured as a voltage, current, or combination thereof. For example, the target output may be 5 kV for each piezoelectric cartridge. In another example, the target output can be a predetermined minimum current through a shunt resistor, among other things.

At 1816, if the target output has not been reached, control systems can adjust the overall pressure on one or more of the cartridges of piezoelectric elements using an adjustment mechanism, which can be the same as, or different from the engagement mechanism, and can be a servo motor controlled, screw type actuator, or other device.

At 1818, once target output of the generator has been achieved, the generator can be loaded, and normal operations can begin.

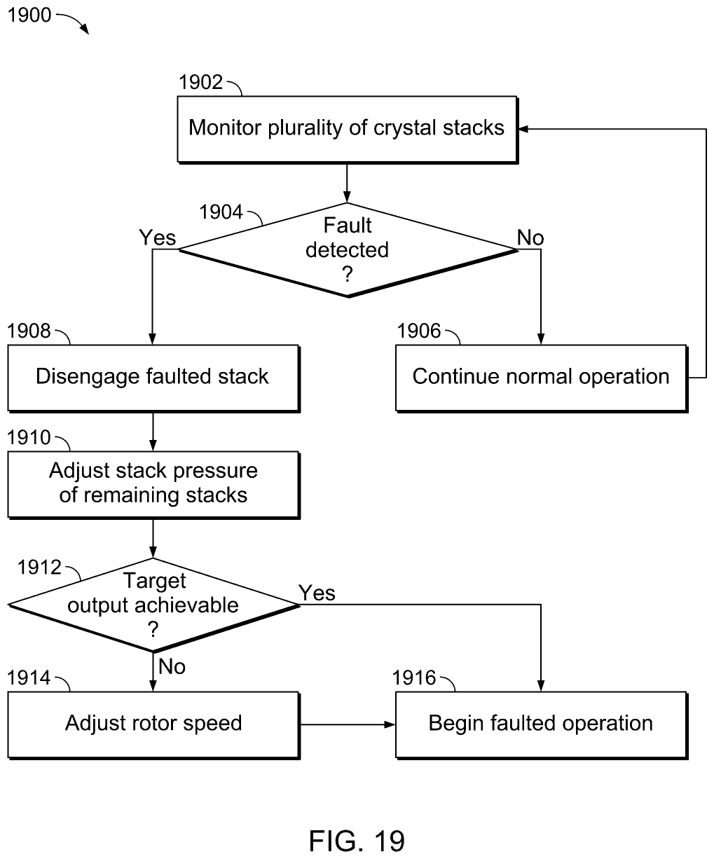

FIG. 19 is a flowchart illustrating an example process 1900 for a generator fault response. The process 1900 can be performed, for example, by any suitable system, environment, software, and hardware, or a combination of systems, environments, software, and hardware as appropriate. In some instances, process 1900 can be performed by the system as described in FIGS. 1-17, or portions thereof, as well as other components or functionality described in other portions of this description. In other instances, process 1900 may be performed by a plurality of connected components or systems. Any suitable system(s), architecture(s), or application(s) can be used to perform the illustrated operations. Further it should be noted that not every element of process 1900 applies to every configuration.

At 1902, a plurality of piezoelectric cartridges within piezoelectric cartridges in a piezoelectric generator are monitored for a fault. Faults can be either electrical (e.g., a short circuit or under-producing piezoelectric cartridge) or mechanical (e.g., a cracked or destroyed piezoelectric elements or damaged/failing structural components). Monitoring can be performed via various sensors associated with each cartridge. For example, microphones, vibration sensors, continuity sensors, voltage and current sensors, or other devices can measure for faults. In some implementations, a fault can be inferred based on remote sensors. For example, a measured torque spike in sensed torque of the prime mover at a specific position can indicate a mechanical fault associated with the rocker arm or piezoelectric elements of a particular cartridge in that position.

At 1904, if a fault is detected, process 1900 proceeds to 1908, otherwise, normal operation can continue (1906).

At 1908, when a fault is detected, the faulted piezoelectric cartridge can be disengaged. This can be performed using, for example, the cartridge adjustment mechanism 310 as illustrated and described in FIG. 3. The faulted piezoelectric cartridge can be fully withdrawn from the rotor to minimize drag and prevent further damage. In some implementations, the faulted piezoelectric cartridge can further be electronically isolated (e.g., using MOSFETS, breakers, or other devices) from the rest of the generator.

At 1910, the output of the remaining piezoelectric cartridges is adjusted to compensate for the disengagement of the faulted piezoelectric cartridge. In some implementations, an average pressure of other piezoelectric cartridges is increased such that the output of the entire generator is not reduced. In some implementations, only neighboring piezoelectric cartridges have their output increased.

At 1912, a determination is made whether the target output is achievable by increasing piezoelectric cartridge pressure alone. If it is, process 1900 proceeds to 1916 where faulted operation begins. Otherwise process 1900 can proceed to 1914.

At 1914, because increasing piezoelectric cartridge pressure alone is not sufficient to compensate for the faulted piezoelectric cartridge, rotor speed can be increased, causing the remaining piezoelectric cartridges to be cycled more rapidly, and therefore produce more power. In some implementations, as rotor speed is increased, the total pressure across the piezoelectric cartridges is reduced as necessary until the target output is reached.

At 1916, faulted operation begins. The generator can continue producing power, and send or otherwise indicate that it has a faulted piezoelectric cartridge. This can enable repair or replacement of the piezoelectric cartridge without necessarily bringing the piezoelectric generator offline. In some implementations, faulted operation includes additional limiting operation parameters, for example, reduced temperature limits, and reduced maximum output power, among other things. Some implementations can include a mechanism that lifts the rocker arm away from the rotor when a cartridge is removed from service.

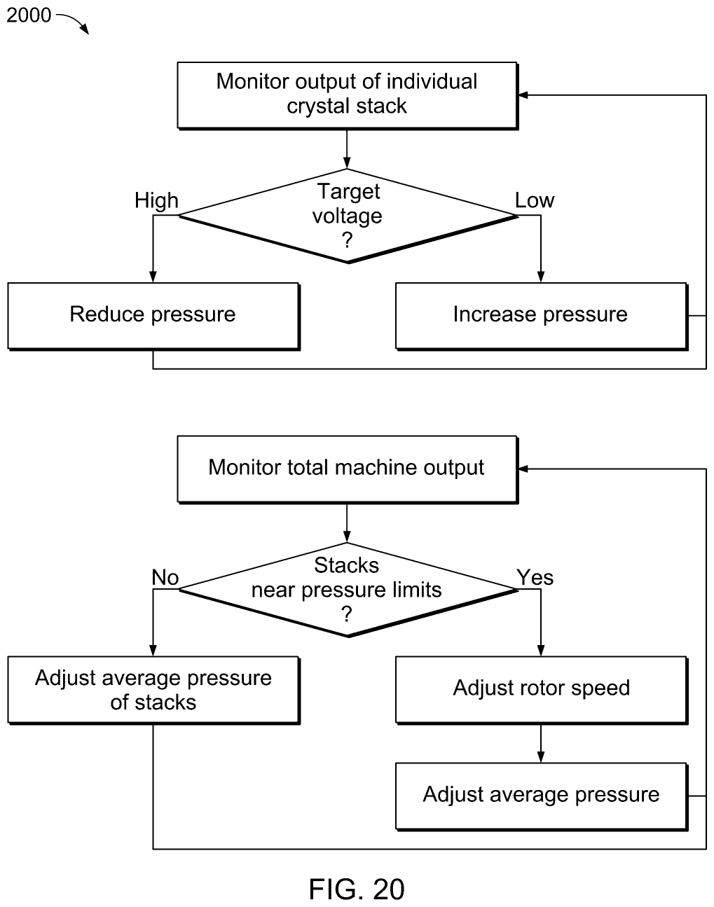

FIG. 20 is a flowchart illustrating an example processes 2000 and 2010 for voltage output control for a piezoelectric generator. The processes 2000 and 2010 can be performed, for example, by any suitable system, environment, software, and hardware, or a combination of systems, environments, software, and hardware as appropriate. In some instances, processes 2000 and 2010 can be performed by the system as described in FIGS. 1-17, or portions thereof, as well as other components or functionality described in other portions of this description. In other instances, processes 2000 and 2010 may be performed by a plurality of connected components or systems. Any suitable system(s), architecture(s), or application(s) can be used to perform the illustrated operations. Further it should be noted that not every element of processes 2000 and 2010 applies to every configuration.

Process 2000 and 2010 can occur simultaneously or sequentially, and can be independent from each other, or share data, sensed parameters, and target outputs. In general, process 2000 represents individual piezoelectric cartridge control for a piezoelectric generator with a plurality of piezoelectric cartridges that each produce some output voltage. Process 2010 represents group piezoelectric cartridge control for the totality of the array of piezoelectric cartridges in the piezoelectric generator. Processes 2000 and 2010 can be implemented using a closed loop control system, such as a PID controller or state space controller, among other things.

At 2002, the output of each individual piezoelectric cartridge is monitored. In some implementations, the monitoring occurs in groups or sets of piezoelectric cartridges. In some implementations, a sensor can be toggled to detect the output of individual piezoelectric cartridges sequentially.

At 2004, it is determined whether the particular piezoelectric cartridge is producing the target output voltage. If the target output voltage is low, process 2000 proceeds to 2008; if the target output voltage is high, process 2000 proceeds to 2006. In some implementations, where the target output voltage has been achieved, process 2000 returns to 2002 where monitoring continues. The target voltage can be a nominal output voltage, determined based on the demand required by the loads on the generator. For example, in a generator with 36 piezoelectric cartridges (e.g., the implementations illustrated in FIG. 13), a target voltage for each piezoelectric cartridge can be selected such that the piezoelectric cartridge produces 1/36^{th} of the overall demanded power.

At 2006, where the piezoelectric cartridge is producing too much voltage, the pressure on that piezoelectric cartridge is reduced. This can be accomplished using a cartridge engagement mechanism or other device that is able to adjust mechanical pressure between the piezoelectric cartridge and the rotor.

At 2008, where the piezoelectric cartridge is producing too little voltage, the pressure on the piezoelectric cartridge can be increased. In some implementations, a check is performed to ensure the piezoelectric cartridge is not at a maximum pressure before increasing the pressure.

Upon completion of adjustments, process 2000 returns to 2002 and individual piezoelectric cartridge monitoring continues.

At 2012, the total machine output is measured. This can be a measured current, voltage, power, or other output parameter associated with the piezoelectric generator. The total machine output can be compared to a demanded output, for example, from loads connected to the machine, or based on a state-of-charge or charging rate of a connected energy storage system.

At 2014, if an adjustment to the output of the generator is required, it can be determined whether the piezoelectric cartridges are near their pressure limits. For example, if any piezoelectric cartridge in the generator is within 10% or 5% of its respective maximum pressure, process 2010 can proceed to 2018, otherwise process 2010 proceeds to 2016.

At 2016, the average pressure across the array of piezoelectric cartridges is adjusted to satisfy the demanded machine output. In some implementations, the average pressure is adjusted uniformly, that is, each piezoelectric cartridge pressure is increased or decreased equally. In some implementations, a normalized adjustment is made, to bring the pressure distribution across the piezoelectric cartridges closer to uniform. For example, if average pressure is to be increased, the piezoelectric cartridges that are at a lower pressure are increased more than piezoelectric cartridges already operating at a high pressure. Additional considerations are possible when balancing pressure across the array of cartridges, including temperature balancing, crystal age, position, device orientation, etc.

At 2018, where at least some piezoelectric cartridges are operating at a pressure near their operating limit, the rotor speed can be adjusted to achieve the desired machine output without exceeding the pressure limits of any individual piezoelectric cartridge. The rotor speed can be ramped up or down, e.g., by a step increase or decrease to achieve an updated target speed.

At 2020, similarly to 2016, the pressures across the entire array of cartridges are adjusted based on the new rotor speed and the target machine output.

Note that in this specification the term “electrically connected” includes the case where components are connected to each other through an object having an electric function. Here, there is no particular limitation on an object having an electric function as long as electric signals and/or electric power can be transmitted and received between components that are connected to each other through the object. Examples of an “object having an electric function” include a switching element such as a transistor, a resistor, an inductor, a capacitor, in addition to an electrode and a wire/cable. Furthermore, references made to a first component as being electrically connected to a specific terminal of a second component are not intended to include an electrical path passing through the second component itself. For example, a capacitor that is electrically connected to a gate terminal of a transistor (or a control terminal of an electric switch) may include the case where the electrical connection passes through other objects or components that have an electric function, but would not include the case where the electrical connection passes through another terminal (e.g., a source/drain) of the transistor itself to the gate of the transistor.

As used herein the term “high voltage” generally refers to the output voltages generated from the piezoelectric elements used in the generator relative to typical commercial and consumer AC power loads (e.g., loads operating below 600V in typical electrical systems). For example, a high voltage would be a voltage above 1 kV and low voltage would be a voltage below 1 kV. As used in reference to portions of the power conversion system, the terms “high voltage,” “high voltage circuit,” “high voltage switch,” “high voltage input,” “low voltage,” “low voltage circuit,” “low voltage switch,” and “low voltage input,” are used in reference to one another. For example, a high voltage circuit of the power conversion system operates at voltages greater than the corresponding low voltage circuit and would separated from each other by a transformer. This discussion is intended to supplement industry usage and definitions (e.g., IEC Standards, NEC standards, ANSI/IEEE Standards, etc.) of similar terms (e.g., “high voltage,” “low voltage,” and “high voltage switch”) for understanding the operations and devices disclosed herein, and not intended as a wholesale replacement of such terms.

Although the disclosed inventive concepts include those defined in the attached claims, it should be understood that the inventive concepts can also be defined in accordance with the following embodiments. In addition to the embodiments of the attached claims and the embodiments described above, the following numbered embodiments are also innovative.

Embodiment 1 is a power generation system comprising: multiple piezoelectric elements; and an actuator configured to convert a rotational power input into a repeatedly varying force applied to the piezoelectric elements, wherein the piezoelectric elements together are configured to output voltage pulses having a peak voltage of at least 5 kV responsive to the applied force.

Embodiment 2 is a method for generating power, the method comprising: repeatedly applying a force of between 3,000 and 6,000 pounds per square inch (psi) to multiple, consecutively arranged piezoelectric elements; by the piezoelectric elements, responsive to the applied force, providing 10,000 W of output power through multiple electric contacts connecting the piezoelectric elements in parallel.

Embodiment 3 is a system for generating power, the system comprising: a rotor; a piston; multiple holders disposed in a consecutive arrangement that extends radially away from an outer circumferential surface of the rotor, each holder having one or more openings defined therethrough; one or more piezoelectric elements corresponding to each holder, the piezoelectric elements disposed in respective openings of the corresponding holders, wherein piezoelectric elements corresponding to an innermost one of the holders is mechanically coupled to the outer circumferential surface of the rotor via the piston; and an electrical contact disposed between each pair of adjacent holders such that the piezoelectric crystals corresponding to each holder are connected in a parallel circuit.

Embodiment 4 is the system of embodiment 3, wherein the rotor has a varying diameter.

Embodiment 5 is the system of embodiment 4, wherein each cycle of the varying diameter comprises a valley portion, a peak portion, an incline portion connecting the valley portion to the peak portion, and a descent portion connecting the peak portion to the valley portion of an adjacent cycle, and wherein the diameter of the rotor at the peak portion is greater than the diameter of the rotor at the valley portion.

Embodiment 6 is the system of embodiment 5, wherein a difference between the diameter of the rotor at the peak portion and the diameter of the rotor at the valley portion is sufficient to compress each piezoelectric element by at least 0.00075 inches.

Embodiment 7 is the system of embodiment 5 or 6, wherein a radial extent of the incline portion is different than a radial extent of the descent portion.

Embodiment 8 is the system of embodiment 7, wherein the radial extent of the incline portion is greater than the radial extent of the descent portion.

Embodiment 9 is the system of any one of embodiment 5 through 8, wherein a radial extent of the valley portion is equal to a radial extent of the peak portion.

Embodiment 10 is the system of any one of embodiment 5 through 9, wherein the incline portion and the descent portion have linear profiles.

Embodiment 11 is the system of any one of embodiments 5 through 10, wherein the rotor comprises a plurality of lobes forming a periodically varying diameter.

Embodiment 12 is the system of any one of embodiments 3 through 10, wherein the rotor comprises a plurality of lobes forming a varying rotor diameter; and wherein the system comprises a timing disk coaxially mounted to the rotor, the timing disk including indicators aligned with the lobes of the rotor.

Embodiment 13 is the system of embodiment 12, comprising an optical sensor positioned to receive input signals from the indicators of the timing disk, the optical sensor configured to be coupled to a timing system.

Embodiment 14 is the system of any one of embodiments 3 through 13, comprising a rocker arm disposed in contact with the outer circumferential surface of the rotor, and wherein the piston is mechanically connected to the rocker arm.

Embodiment 15 is the system of any one of embodiments 3 through 14, comprising a housing extending radially away from the outer circumferential surface of the rotor, wherein the holders are disposed in the housing.

Embodiment 16 is the system of embodiment 15, comprising multiple housings disposed radially around the rotor, each housing extending radially away from the outer circumferential surface of the rotor; wherein multiple holders are disposed in each housing, and wherein the holders disposed in each respective housing are disposed in a consecutive arrangement extending radially away from the outer circumferential surface of the rotor.

Embodiment 17 is the system of any one of embodiments 3 through 16, wherein each piezoelectric element is an elongated element having a length greater than a width, and wherein the piezoelectric elements are disposed in the respective openings such that the lengths of the piezoelectric elements extend radially away from the outer circumferential surface of the rotor.

Embodiment 18 is the system of embodiment 17, wherein an aspect ratio of the piezoelectric elements is between 1:1 and 10:1.

Embodiment 19 is the system of embodiment 17 or 18, wherein the length of each piezoelectric element is between 1 and 3 inches.

Embodiment 20 is the system of any one of embodiments 17 through 19, wherein the piezoelectric elements have a circular cross-section.

Embodiment 21 is the system of any one of embodiments 17 through 20, wherein the piezoelectric elements are crystalline.

Embodiment 22 is the system of embodiment 21, wherein each piezoelectric element is a single crystalline material.

Embodiment 23 is the system of any one of embodiments 17 through 22, wherein the piezoelectric elements comprise one or more of: lead magnesium niobate-lead titanate (PMN-PT), lead magnesium niobate-lead zirconate titanate (PMN-PZT), barium titanate (BaTiO₃), barium calcium titanate (BCT), barium zirconate titanate (BZT), potassium niobate (KnbO₃), sodium tungstate (Na₂WO₃), bismuth titanate (Bi₄Ti₃O₁₂), or sodium bismuth titanate (NaBi(TiO₃)₂).

Embodiment 24 is the system of any one of embodiments 3 through 23, wherein multiple openings are defined through each holder.

Embodiment 25 is the system of embodiment 24, wherein the openings through each holder are arranged in a hexagonal array.

Embodiment 26 is the system embodiment 24 or 25, wherein the openings through each holder are arranged in a rectangular array.

Embodiment 27 is the system of any one of embodiments 3 through 26, wherein the holders are electrically insulating.

Embodiment 28 is the system of any one of embodiments 3 through 27, comprising a cartridge adjustment mechanism configured to control a stress applied to the piezoelectric elements by the piston.

Embodiment 29 is the system of embodiment 28, wherein the cartridge adjustment mechanism comprises a servo motor.

Embodiment 30 is the system of embodiment 28 or 29, wherein the cartridge adjustment mechanism is disposed at an end of the housing furthest from the rotor.

Embodiment 31 is the system of any one of embodiments 28 through 30, wherein the cartridge adjustment mechanism is configured to move the holders relative to the rotor.

Embodiment 32 is the system of any one of embodiments 3 through 31, comprising first wiring electrically connected to a first group of the electrical contacts and second wiring electrically connected to a second, different group of the electrical contacts.

Embodiment 33 is the system of any one of embodiments 3 through 32, wherein the electrical contacts comprise a thermally conductive material.

Embodiment 34 is the system of any one of embodiments 3 through 33, wherein the electrical contacts comprise metal sheets.

Embodiment 35 is the system of any one of embodiments 3 through 34, wherein the electrical contacts are coupled to a high voltage power conversion system.

Embodiment 36 is the system of any one of embodiments 3 through 35, wherein the system is configured to output a series high voltage short duration energy pulses through the electrical contacts.

Embodiment 37 is the system of embodiment 36, wherein the energy pulses have a voltage of 5 kV or greater and a period of 2 ms or less.

Embodiment 38 is a power generation system comprising:multiple sets of one or more piezoelectric elements, wherein the sets of piezoelectric elements are arranged consecutively; means for applying a repeated stress to the piezoelectric elements; and a pair of electrical contacts corresponding to each set of piezoelectric elements, each pair of electrical contacts connecting the piezoelectric elements of the corresponding set in a parallel circuit arrangement.

Embodiment 39 is a system for generating power, the system comprising: a rotor having a varying diameter; a rocker arm disposed in contact with the outer circumferential surface of the rotor; a piston mechanically connecting to the rocker arm. a housing extending radially away from an outer circumferential surface of the rotor; multiple holders disposed within the housing, the holders arranged consecutively along a length of the housing, each holder having one or more openings defined therethrough; one or more elongated piezoelectric elements corresponding to each holder, the piezoelectric elements disposed in respective openings of the corresponding holders, wherein distal ends of the piezoelectric elements in an outermost one of the holders have a fixed position relative to a center of the rotor, and wherein innermost surfaces of the piezoelectric elements in an innermost one of the holders are mechanically coupled to the rotor via the piston and rocker arm; multiple electrical contacts, each electrical contact disposed between a corresponding pair of adjacent holders and in physical and electrical contact with (1) outermost surfaces of the piezoelectric crystals disposed in an innermost holder of the pair and (2) innermost surfaces of the piezoelectric crystals disposed in an outermost holder of the pair; a power conversion system (PCS) electrically connected to outputs of the multiple electrical contacts, the high voltage power conversion system comprising: a high voltage input electrically connected to the outputs of the multiple electrical contacts; an inductor having a first terminal and a second terminal; a transformer having a primary side input and a secondary side output; a first pair of high voltage switching devices electrically connected between the high voltage input and the inductor, wherein the first pair of high voltage switches are arranged to selectively isolate the first and second terminals of the inductor form the high voltage input; a second pair of high voltage switching device electrically connected between the inductor and the primary side input of the transformer, wherein the second pair of high voltage switching devices are arranged to selectively isolate the first and second terminals of the inductor from the primary side input of the transformer; and a second stage circuit electrically connected to the secondary side output of the transformer and configured to convert electrical power output from the secondary side output of the transformer into output electrical power having characteristics compatible with one or more electrical loads.

Embodiment 40 is an apparatus comprising: an elongated housing defining an interior space; multiple cassettes disposed in a stack in the interior space of the housing, wherein the cassettes are formed of an electrically insulating material, wherein one or more openings are defined through each cassette, each opening sized to receive an elongated piezoelectric element; and an endpiece disposed at an end of the elongated housing, wherein a position of the endpiece along a length of the elongated housing is adjustable.

Embodiment 41 is a method for generating a voltage, the method comprising: rotating a rotor having a varying diameter, the rotation of the rotor causing application of a repeating stress to piezoelectric elements housed in consecutively arranged holders extending radially away from an outer circumference of the rotor; by the piezoelectric elements, generating voltage pulses responsive to the repeating stress; and outputting, to a high voltage power conversion system, the generated voltage pulses through electrical contacts disposed between each pair of adjacent holders, wherein the electrical contacts connect in parallel the piezoelectric crystals housed in each holder.

Embodiment 42 is the method of embodiment 41, comprising rotating a timing disk coaxially mounted to the rotor, the timing disk including indicators aligned with the variations in the diameter of the rotor.

Embodiment 43 is the method of embodiment 42, comprising receiving, by an optical sensor, input signals from the indicators of the timing disk, the optical sensor coupled to a timing system.

Embodiment 44 is the method of embodiment 43, comprising controlling, by the timing system, a timing for operation of the high voltage power conversion system.

Embodiment 45 is the method of any one of embodiments 41 through 44, wherein outputting the generated voltage pulses comprises outputting a series high voltage short duration energy pulses through the electrical contacts.

Embodiment 46 is the method of embodiment 45, wherein comprising outputting energy pulses having a voltage of 5 kV or greater and a period of 2 ms or less.

Embodiment 47 is a system for generating power, the system comprising: a rotor; a piston; multiple holders disposed in a consecutive arrangement that extends radially away from an outer circumferential surface of the rotor, each holder having one or more openings defined therethrough; one or more piezoelectric elements corresponding to each holder, the piezoelectric elements disposed in respective openings of the corresponding holders, wherein piezoelectric elements corresponding to an innermost one of the holders is mechanically coupled to the outer circumferential surface of the rotor via the piston; an electrical contact disposed between each pair of adjacent holders such that the piezoelectric elements corresponding to each holder are connected in a parallel circuit; a high voltage power conversion system (PCS) electrically connected to an output of the parallel circuit, the PCS configured to convert a series of short duration high voltage pulses (SDHVP) into a stable low-voltage output, wherein a period of the Voltage pulses is shorter than 2 ms and a peak voltage of the Voltage pulses is at least 5 kV, and wherein the low-voltage output has a voltage of less than 1 kV.

Embodiment 48 is the system of embodiment 47, wherein the PCS comprises: a energy collector circuit (ECC) comprising two sets of high voltage switching devices arranged in series between the output of the parallel circuit and an output of the ECC with an inductive component electrically connected between the two sets of high voltage switching devices; and switching circuitry configured to alternately operate each set of high voltage switching devices such that electrical charge output by the piezoelectric elements is sequentially transferred to the inductive component and then to the output of the ECC while maintaining the output of the ECC electrically isolated from the piezoelectric elements.

Embodiment 49 is a high voltage power conversion system (PCS) configured to convert a series of voltage pulses from piezoelectric elements into a stable low-voltage output, wherein a period of the Voltage pulses is shorter than 2 ms and a peak voltage of the Voltage pulses is at least 5 kV, and wherein the low-voltage output has a voltage of less than 1 kV.

Embodiment 50 is the system of embodiment 49, comprising a high voltage energy collector circuit (ECC) comprising: two sets of high voltage switching devices arranged in series between an output of the piezoelectric elements and an output of the ECC with an inductive component electrically connected between the two sets of high voltage switching devices; and switching circuitry configured to alternately operate each set of high voltage switching devices such that electrical charge output by the piezoelectric elements is sequentially transferred to the inductive component and then to the output of the ECC while maintaining the output of the ECC electrically isolated from the piezoelectric elements.

Embodiment 51 is the system of embodiment 50, wherein the PCS has a power conversion efficiency of at least 70%.

Embodiment 52 is a power conversion (PCS) system comprising: a first stage circuit configured as an energy collector, the first stage circuit comprising: an input coupled to an electrical output of at least one set of piezoelectric elements; an inductor having a first terminal and a second terminal; a transformer having a primary side input and a secondary side output; a first pair of high voltage switching devices electrically connected between the high voltage input and the inductor, wherein the first pair of high voltage switches are arranged to selectively isolate the first and second terminals of the inductor form the high voltage input; and a second pair of high voltage switching device electrically connected between the inductor and the primary side input of the transformer, wherein the second pair of high voltage switching devices are arranged to selectively isolate the first and second terminals of the inductor from the primary side input of the transformer; and a second stage circuit electrically connected to the secondary side output of the transformer and configured to convert electrical power output from the secondary side output of the transformer into output electrical power having characteristics compatible with one or more electrical loads.

Embodiment 53 is the system of embodiment 52, further comprising switch control circuitry configured to alternately operate the first pair of high voltage switching devices and the second pair of high voltage switching devices such that electrical charge output by the piezoelectric elements is sequentially transferred through the first pair of switching devices to the inductor and then through the second set of high voltage switching devices to the primary side input of the transformer while maintaining the piezoelectric elements electrically isolated from the primary side input of the transformer.

Embodiment 54 is the system of embodiments 52 or 53, wherein the first stage circuit on the primary side of the transformer is ungrounded.

Embodiment 55 is the system of any one of embodiments 52 through 54, wherein the first stage circuit comprises a rectifier circuit electrically coupled between the input and the first pair of high voltage switching devices.

Embodiment 56 is the system of any one of embodiments 52 through 55, wherein the first stage circuit does not include a rectifier circuit and is configured convert electrical charge output from the at least one set of piezoelectric elements into an alternating current waveform.

Embodiment 57 is the system of any one of embodiments 52 through 56, wherein the first stage circuit comprises a storage capacitor connected at the secondary side output of the transformer, and wherein the storage capacitor has a capacitance at least 100 times greater than an effective output capacitance of the piezoelectric elements.

Embodiment 58 is the system of any one of embodiments 52 through 57, wherein at least one of the high voltage switching devices comprises a high voltage MOSFET, a diamond substrate switch, an optical transconductance varistor.

Embodiment 59 is the system of any one of embodiments 52 through 58, further comprising an electrical surge volume electrically connected to an output of the second stage circuit, and control circuitry configured to selectively divert output power from the output of the second stage circuit to an electrical power network or to the electrical surge volume responsive to changes in electrical power demand on the electrical power network.

Embodiment 60 is the system of embodiment 59, wherein the electrical surge volume comprises at least one of a bank of batteries or a bank of supercapacitors.

Embodiment 61 is a high voltage electricity harvesting method comprising: receiving a series of high voltage short duration electrical charge pulses from piezoelectric elements of a piezoelectric generator; capturing electrical charge from each charge pulse in a power conversion circuit that is synchronized with a rotor of the piezoelectric generator, the rotor comprising a plurality of cam surfaces; storing, between charge pulses, a captured portion of energy in an inductive component; and converting the captured portion of energy to a low-voltage output.

Embodiment 62 is the method of embodiment 61, wherein the charge pulses have a voltage of 5 kV or greater and a period of 2 ms or less and wherein the low voltage output has a voltage of 1 kV or less.

Embodiment 63 is the method of embodiment 61 or 62, wherein capturing the electrical charge comprises alternately operating two sets of high voltage switching devices such that each charge pulse output by the piezoelectric elements is sequentially transferred first from the piezoelectric elements to the inductive component and then from the inductive element to an electrical output while maintaining the electrical output electrically isolated from the piezoelectric elements.

Embodiment 64 is the method of any one of embodiments 61 through 63, wherein capturing the electrical charge from each charge pulse is initiated by a triggering signal from an optical triggering system timed with rotation of the rotor.

Embodiment 65 is a timing system for a piezoelectric generator, the timing system comprising: an optical sensor positioned to receive input signals from a timing disk coaxially mounted to a rotor of a piezoelectric generator, the optical sensor configured to generate output pulses responsive to the input signals; and a triggering circuit configured to generate triggering pulses from the output pulses of the optical sensor, wherein an output of the triggering circuit is connected to a gate driver circuit for a power conversion system through an opto-isolator.

Embodiment 66 is the system of embodiment 65, wherein the timing disk is calibrated to generate input signals for the optical sensor at a peak compression of a stack of piezoelectric crystals and at peak relaxation of the stack of piezoelectric crystals.

Embodiment 67 is an electrical charge harvesting system comprising: a tubular housing comprising a plurality of cassettes stacked within the tubular housing to form a stack of cassettes, each cassette comprising a plurality of piezoelectric crystals arranged in a single layer with opposing ends of each piezoelectric crystal exposed through a top and a bottom of the cassette; a metallic plate positioned between each pair of neighboring cassettes within the stack of cassettes, wherein a first surface of the metallic plate is in electrical contact with one end of a first set of piezoelectric crystals contained in a first one of the pair of neighboring cassettes and a second, different, surface of the metallic plate is in electrical contact with one end of a second set of piezoelectric crystals contained in a second one of the pair of neighboring cassettes; and a first wiring connected to a first set of the metallic plates; and a second wiring connected to a second, different, set of the metallic plates

Embodiment 68 is the system of embodiment 67, wherein the metallic plates comprise copper.

Embodiment 69 is the system of embodiment 67 or 68, wherein the metallic plates comprise a beryllium copper alloy.

Embodiment 70 is the system of any one of embodiments 67 through 69, wherein the metallic plates form a heat sink for the piezoelectric crystals.

Embodiment 71 is a piezoelectric generator operating method comprising: controlling a prime mover to initiate rotation of a rotor and drive the rotor at a predetermined rotational speed; controlling a cartridge adjustment mechanism to position a piezoelectric cartridge in mechanical communication with the rotor, wherein the piezoelectric cartridge comprises a stack of piezoelectric elements, a compression mechanism, and an electrical output, wherein the cartridge mechanism is configured to move the piezoelectric cartridge radially relative to the rotor such that the compressing mechanism contacts a surface of the rotor; obtaining a voltage measurement at the electrical output of the piezoelectric cartridge; and responsive to the voltage measurement, adjusting a position of the piezoelectric cartridge relative to the rotor until a predetermined output voltage is achieved.

Embodiment 72 is the method of embodiment 71, wherein adjusting the position of the piezoelectric cartridge relative to the rotor comprises moving the piezoelectric cartridge radially closer to the rotor responsive to the voltage measurement being less than the predetermined output voltage.

Embodiment 73 is the method of embodiment 71 or 72, wherein adjusting the position of the piezoelectric cartridge relative to the rotor comprises moving the piezoelectric cartridge radially away from the rotor responsive to the voltage measurement being greater than the predetermined output voltage.

Embodiment 74 is the method of any one of embodiments 71 through 73, wherein controlling the cartridge adjustment mechanism comprises operating an electric motor to rotate a position adjustment screw of the cartridge adjustment mechanism.

Embodiment 75 is a piezoelectric generator operating method comprising: monitoring operation of a piezoelectric generator comprising a plurality of piezoelectric cartridges spaced radially around rotor, each piezoelectric cartridge comprising a stack of piezoelectric elements in mechanical communication with a compression mechanism, wherein the compression mechanism of each piezoelectric cartridge is in mechanical contact with the rotor; detecting a fault in a particular piezoelectric cartridge; and responsive to detecting the fault, removing the particular piezoelectric cartridge from operation.

Embodiment 76 is the method of embodiment 75, wherein removing the particular cartridge from operation comprises controlling a cartridge adjustment mechanism to move the particular piezoelectric cartridge radially away from the rotor.

Embodiment 77 is the method of embodiments 75 or 76, wherein removing the particular piezoelectric cartridge from operation comprises shorting an electrical output of the piezoelectric cartridge to ground.

Embodiment 78 is a piezoelectric generator operating method comprising: monitoring operation of a piezoelectric generator comprising a plurality of piezoelectric cartridges spaced radially around a rotor, each piezoelectric cartridge comprising a stack of piezoelectric elements in mechanical communication with a compression mechanism, wherein the compression mechanism of each piezoelectric cartridge is in mechanical contact with a surface of the rotor; obtaining voltage measurements at electrical outputs from a set of the piezoelectric cartridge; determining that a voltage measurement for a particular piezoelectric cartridge is outside of a predetermined operating range; and responsive to determining that the voltage measurement for the particular piezoelectric cartridge is outside of the predetermined operating range, adjusting a position of the particular piezoelectric cartridge relative to the rotor, thereby, adjusting a compression pressure on the stack of piezoelectric elements within the particular piezoelectric cartridge.

Embodiment 79 is the method of embodiment 78, wherein adjusting the position of the piezoelectric cartridge relative to the rotor comprises moving the piezoelectric cartridge radially closer to the rotor responsive to the voltage measurement being less than the predetermined operating range.

Embodiment 80 is the method of embodiment 78 or 79, wherein adjusting the position of the piezoelectric cartridge relative to the rotor comprises moving the piezoelectric cartridge radially away from the rotor responsive to the voltage measurement being greater than the predetermined operating range.

Embodiment 81 is the method of any one of embodiments 78 through 80, wherein adjusting a position of the particular piezoelectric cartridge relative to the rotor comprises controlling a cartridge adjustment mechanism to move the particular piezoelectric cartridge radially away from the rotor.

Embodiment 82 is the method of embodiments 81, wherein controlling the cartridge adjustment mechanism comprises operating an electric motor to rotate a position adjustment screw of the column adjustment mechanism.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations but is to be accorded the widest scope consistent with the principles and features disclosed herein. Particular embodiments of the subject matter have been described. Other embodiments are within the scope of the following claims.

1. (canceled)

2. A system for generating power, the system comprising:
a rotor;
a piston;
multiple holders disposed in a consecutive arrangement that extends radially away from an outer circumferential surface of the rotor, each holder having one or more openings defined therethrough;
one or more piezoelectric elements corresponding to each holder, the piezoelectric elements disposed in respective openings of the corresponding holders, wherein piezoelectric elements corresponding to an innermost one of the holders is mechanically coupled to the outer circumferential surface of the rotor via the piston; and
an electrical contact disposed between each pair of adjacent holders such that the piezoelectric elements corresponding to each holder are connected in a parallel circuit.

3. The system of claim 2, wherein the rotor has a varying diameter, wherein each cycle of the varying diameter comprises a valley portion, a peak portion, an incline portion connecting the valley portion to the peak portion, and a descent portion connecting the peak portion to the valley portion of an adjacent cycle, and wherein the diameter of the rotor at the peak portion is greater than the diameter of the rotor at the valley portion.

4. The system of claim 3, wherein a difference between the diameter of the rotor at the peak portion and the diameter of the rotor at the valley portion is sufficient to compress each piezoelectric element by at least 0.00075 inches.

5. The system of claim 3, wherein the rotor comprises a plurality of lobes forming a periodically varying diameter.

6. The system of claim 2, comprising a rocker arm disposed in contact with the outer circumferential surface of the rotor, and wherein the piston is mechanically in contact with the rocker arm.

7. The system of claim 2, comprising a housing extending radially away from the outer circumferential surface of the rotor, wherein the holders are disposed in the housing.

8. The system of claim 7, comprising multiple housings disposed radially around the rotor, each housing extending radially away from the outer circumferential surface of the rotor;
wherein multiple holders are disposed in each housing, and
wherein the holders disposed in each respective housing are disposed in a consecutive arrangement extending radially away from the outer circumferential surface of the rotor.

9. The system of claim 2, wherein each piezoelectric element is an elongated element having a length greater than a width, and wherein the piezoelectric elements are disposed in the respective openings such that the lengths of the piezoelectric elements extend radially away from the outer circumferential surface of the rotor.

10. The system of claim 9, wherein an aspect ratio of the piezoelectric elements is between 1:1 and 10:1, and wherein the length of each piezoelectric element is between 1 and 3 inches.

11. The system of claim 9, wherein the piezoelectric elements have a circular cross-section.

12. The system of claim 9, wherein the piezoelectric elements are crystalline.

13. The system of claim 9, wherein the piezoelectric elements comprise one or more of: lead magnesium niobate-lead titanate (PMN-PT), lead magnesium niobate-lead zirconate titanate (PMN-PZT), barium titanate (BaTiO₃), barium calcium titanate (BCT), barium zirconate titanate (BZT), potassium niobate (KnbO₃), sodium tungstate (Na₂WO₃), bismuth titanate (Bi₄Ti₃O₁₂), or sodium bismuth titanate (NaBi(TiO₃)₂).

14. The system of claim 2, comprising a cartridge adjustment mechanism configured to control a static stress applied to the piezoelectric elements by the piston.

15. The system of claim 14, wherein the cartridge adjustment mechanism comprises a servo motor.

16. The system of claim 14, wherein the cartridge adjustment mechanism is configured to move the holders relative to the rotor.

17. The system of claim 2, wherein the system is configured to output a series of energy pulses through the electrical contacts, wherein the energy pulses have a voltage of 5 kV or greater and a period of 2 ms or less.

18. The system of claim 2, comprising:
a power conversion system (PCS) electrically connected to a high-voltage output of the parallel circuit, the PCS configured to convert a series of voltage pulses into a stable low-voltage output, wherein a period of the voltage pulses is shorter than 2 ms and a peak voltage of the voltage pulses is at least 5 kV, and wherein the stable low-voltage output has a voltage of less than 1 kV.

19. The system of claim 18, wherein the PCS comprises:
an energy collector circuit (ECC) comprising two sets of switching devices arranged in series between the output of the parallel circuit and an output of the ECC with an inductive component electrically connected between the two sets of switching devices; and switching circuitry configured to alternately operate each set of switching devices such that electrical charge output by the piezoelectric elements is sequentially transferred to the inductive component and then to the output of the ECC while maintaining the output of the ECC electrically isolated from the piezoelectric elements.

20. A system for generating power, the system comprising:
a rotor having a varying diameter;
a rocker arm disposed in contact with an outer circumferential surface of the rotor;
a piston mechanically in contact with the rocker arm.
a housing extending radially away from an outer circumferential surface of the rotor;
multiple holders disposed within the housing, the holders arranged consecutively along a length of the housing, each holder having one or more openings defined therethrough;
one or more elongated piezoelectric elements corresponding to each holder, the piezoelectric elements disposed in respective openings of the corresponding holders, wherein distal ends of the piezoelectric elements in an outermost one of the holders have a fixed position relative to a center of the rotor, and wherein innermost surfaces of the piezoelectric elements in an innermost one of the holders are mechanically coupled to the rotor via the piston and rocker arm;
multiple electrical contacts, each electrical contact disposed between a corresponding pair of adjacent holders and in physical and electrical contact with (1) outermost surfaces of the piezoelectric elements disposed in an innermost holder of the pair and (2) innermost surfaces of the piezoelectric elements disposed in an outermost holder of the pair;
a power conversion system (PCS) electrically connected to outputs of the multiple electrical contacts, the power conversion system comprising:
an input electrically connected to the outputs of the multiple electrical contacts;
an inductor having a first terminal and a second terminal;
a transformer having a primary side input and a secondary side output;
a first pair of switching devices electrically connected between the input and the inductor, wherein the first pair of switches are arranged to selectively isolate the first and second terminals of the inductor form the input;
a second pair of switching device electrically connected between the inductor and the primary side input of the transformer, wherein the second pair of switching devices are arranged to selectively isolate the first and second terminals of the inductor from the primary side input of the transformer; and
a second stage circuit electrically connected to the secondary side output of the transformer and configured to convert electrical power output from the secondary side output of the transformer into output electrical power having characteristics compatible with one or more electrical loads.

21. The system of claim 3, wherein a radial extent of the incline portion is different than a radial extent of the descent portion.

22. The system of claim 21, wherein the radial extent of the incline portion is greater than the radial extent of the descent portion.

23. The system of claim 2, comprising:
a power conversion system (PCS) electrically connected to an output of the parallel circuit, the PCS configured to convert a series of voltage pulses from the parallel circuit into a direct current (DC) output, wherein a period of the voltage pulses is shorter than 2 ms and a peak voltage of the voltage pulses is at least 5 kV, and wherein the DC output has a voltage of less than 1 kV.

24. The system of claim 23, comprising an energy storage system electrically connected to an power output of the PCS.

25. The system of claim 2, comprising:
a driveshaft mechanically coupled to the rotor; and
a combustion engine coupled to the driveshaft and configured to mechanically rotate the rotor.

26. A system for generating power, the system comprising:
a prime mover configured to mechanically rotate a driveshaft; and
a plurality of piezoelectric generators, each piezoelectric generator comprising:
a rotor coupled to the driveshaft;
a piston;
multiple holders disposed in a consecutive arrangement that extends radially away from an outer circumferential surface of the rotor, each holder having one or more openings defined therethrough;
one or more piezoelectric elements corresponding to each holder, the piezoelectric elements disposed in respective openings of the corresponding holders, wherein piezoelectric elements corresponding to an innermost one of the holders is mechanically coupled to the outer circumferential surface of the rotor via the piston;
an electrical contact disposed between each pair of adjacent holders such that the piezoelectric elements corresponding to each holder are connected in a parallel circuit; and
a power conversion system (PCS) electrically connected to an output of the parallel circuit, the PCS configured to convert a series of voltage pulses from the parallel circuit into a direct current (DC) output and provide the DC output to a power output of the PCS, wherein a period of the voltage pulses is shorter than 2 ms and a peak voltage of the voltage pulses is at least 5 kV, and wherein the DC output has a voltage of less than 1 kV.

27. The system of claim 26, wherein each rotor has a varying diameter, wherein each cycle of the varying diameter comprises a valley portion, a peak portion, an incline portion connecting the valley portion to the peak portion, and a descent portion connecting the peak portion to the valley portion of an adjacent cycle, and wherein the diameter of each rotor at the peak portion is greater than the diameter of the rotor at the valley portion.

28. The system of claim 26, wherein each piezoelectric generator comprises a rocker arm disposed in contact with the outer circumferential surface of the rotor, and wherein the piston is mechanically in contact with the rocker arm.

29. The system of claim 26, wherein each piezoelectric generator comprises a housing extending radially away from the outer circumferential surface of the rotor, wherein the holders are disposed in the housing.

30. The system of claim 29, wherein each piezoelectric generator comprises multiple housings disposed radially around the rotor, each housing extending radially away from the outer circumferential surface of the rotor;
wherein multiple holders are disposed in each housing, and
wherein the holders disposed in each respective housing are disposed in a consecutive arrangement extending radially away from the outer circumferential surface of the rotor.

31. The system of claim 26, wherein each piezoelectric generator comprises a cartridge adjustment mechanism configured to control a static stress applied to the piezoelectric elements by the piston.
